(19) United States
(12) Patent Application Publication
(10) Pub. No.: US 2025/0068848 A1
(43) Pub. Date: Feb. 27, 2025

(54) METHOD OF CLUSTERING KEYWORD AND AN ELECTRONIC DEVICE THEREOF

(71) Applicant: Dunamu Inc., Seoul (KR)

(72) Inventors: Dongjun LEE, Seoul (KR); Jaehyuk KIM, Seoul (KR); Seokhyun HWANG, Gwangju-si (KR)

(21) Appl. No.: 18/811,293

(22) Filed: Aug. 21, 2024

(30) Foreign Application Priority Data
Aug. 25, 2023 (KR) 10-2023-0111905

(51) Int. Cl. G06F 40/295

(52) U.S. Cl. CPC G06F 40/295

(57) ABSTRACT

A method of clustering keywords includes identifying a text set including at least one text element, identifying a keyword set including a keyword in the at least one text element, the keyword set including at least one target keyword, identifying at least one vector corresponding to each of the at least one target keyword. An element of the at least one vector is identified based on a degree of association between the at least one target keyword and each of keywords included in the keyword set, the degree of association is identified based on the text set. The method includes identifying a similarity between the at least one target keyword, based on the identified at least one vector. The method includes identifying at least one set including at least some of the at least one target keyword, by clustering the at least one target keyword based on the similarity.

### CROSS-REFERENCE TO RELATED APPLICATION(S)

This application claims the benefit of Korean Patent Application No. 10-2023-0111905, filed on Aug. 25, 2023, in the Korean Intellectual Property Office, the disclosure of which is incorporated herein by reference.

### BACKGROUND

### Technical Field

Example embodiments relate to a method of clustering keywords and an electronic device performing the same.

### Description of the Related Art

Information on stocks is provided to investors through financial news or broadcast media. Stocks may be manually classified as stocks related to a specific sector or stocks related to a specific theme. Specifically, in an investment environment where passive investment through exchanged-traded funds (ETFs) is increasing, stocks that are related to each other may have a greater tendency for their prices to fluctuate in similar patterns.

### BRIEF SUMMARY

An aspect provides a method of clustering keywords and an electronic device performing the same.

The technical problems to be solved by the present disclosure are not limited to the technical problems described above, and other technical problems may be inferred from the following example embodiments.

According to an aspect, there is provided a method of clustering keywords by an electronic device, the method including identifying a text set including at least one text element, identifying a keyword set including a keyword in the at least one text element, the keyword set including at least one target keyword, identifying at least one vector corresponding to each of the at least one target keyword, an element of the at least one vector being identified based on a degree of association between the at least one target keyword and each of keywords included in the keyword set, the degree of association being identified based on the text set, based on the identified at least one vector, identifying a similarity between the at least one target keyword, by clustering the at least one target keyword based on the similarity, identifying at least one set including at least some of the at least one target keyword, and generating information about the at least one set.

According to an example embodiment, the text set may include unstructured data related to finance, and the at least one text element may include at least one sentence in the unstructured data related to finance.

According to an example embodiment, the keyword set may include a keyword included in the at least one text element which is identified through a named entity recognition (NER) model based on deep learning and a keyword of a set word class in the at least one text element which is identified with morpheme analyzing.

According to an example embodiment, the identifying of the at least one vector may comprise identifying a total number of times that keyword pairs each having a combination of any one of the keywords included in the keyword set and any one of the at least one target keyword are included together in each of the at least one text element included in the text set, and the degree of association may be identified based on the identified total number of times.

According to an example embodiment, the method may further include determining a co-occurrence graph based on the keyword set and the total number of times, the co-occurrence graph may include nodes and an edges connecting the nodes, each of the nodes may correspond to one of the keywords included in the keyword set, and a weight of each of the edges may be identified based on a total number of times in which two keywords corresponding to each of a first node and a second node that are connected to the each of the edges are included together in each of the at least one text element.

According to an example embodiment, the information about the at least one set may include information about a representative keyword of each of the at least one set, and a first representative keyword corresponding to a first set among the at least one set may be determined based on at least one first vector corresponding to at least one first target keyword included in the first set.

According to an example embodiment, when the first representative keyword is plural, a sort order of the plurality of first representative keywords may be determined based on a degree of association between each of the plurality of first representative keywords and each of the at least one first target keyword.

According to an example embodiment, the generating of the information about the at least one set may comprise, based on information about a rate of return of a target keyword included in each of the at least one set, identifying at least one average rate of return corresponding to the at least one set.

According to an example embodiment, wherein, a first centroid vector corresponding to a first set among the at least one set is identified based on a normalized at least one first vector obtained by normalizing at least one first vector corresponding to at least one first target keyword included in the first set according to a set rule.

According to an example embodiment, the identifying of the at least one set may comprise identifying a first vector corresponding to a first target keyword included in a first set among the at least one set, identifying at least one second centroid vector corresponding to at least one second set other than the first set among the at least one set, among the at least one second set, identifying a third set in which a similarity between the first vector and the at least one second centroid vector is greater than or equal to a set value, and re-identifying the third set in order that the first target keyword is further included in the third set.

According to an example embodiment, the identifying of the similarity may comprise, based on a cosine similarity between the at least one vector, identifying the similarity between the at least one target keyword.

According to an example embodiment, the identifying of the keyword set may comprise identifying at least one first text element corresponding to a set type among the at least one text element and identifying a keyword in at least one second text element after the at least one first text element among the at least one text element is filtered.

According to an example embodiment, the identifying of the keyword set may comprise identifying at least one first text element corresponding to a set type among the at least one text element, identifying a second text set in which first text data including the at least one first text element is filtered from the text set, and identifying a keyword in at least one second text element included in the second text set.

According to an example embodiment, the text set may include text data generated within a set period of time.

According to an example embodiment, the identifying of the total number of times may comprise, based on information about a generation time of each of text data included in the text set, determining a first weight of each of the text data and, based on the total number of times and the first weight, identifying a modified total number of times for each of the keyword pairs.

According to an example embodiment, the identifying of the at least one set may comprise, based on hierarchical clustering using the similarity, identifying the at least one set including at least some of the at least one target keyword.

According to an example embodiment, a target keyword set may include a keyword corresponding to a stock listed on a predetermined exchange, the at least one target keyword may be a keyword that is included in both the keyword set and the target keyword set, and as the target keyword set is updated, the at least one target keyword may be updated to include a target keyword included in the updated target keyword set among the keywords included in the keyword set.

According to another aspect, there is provided an electronic device including one or more processors and a memory storing one or more instructions that are executed by the one or more processors. By executing the one or more instructions, the one or more processors may be configured to identify a text set including at least one text element, identify a keyword set including a keyword in the at least one text element, the keyword set including at least one target keyword, identify at least one vector corresponding to each of the at least one target keyword, an element of the at least one vector being identified based on a degree of association between the at least one target keyword and each of keywords included in the keyword set, the degree of association being identified based on the text set, based on the identified at least one vector, identify a similarity between the at least one target keyword, by clustering the at least one target keyword based on the similarity, identify at least one set including at least some of the at least one target keyword, and generate information about the at least one set.

According to another aspect, there is provided a non-transitory computer-readable recording medium having a program for executing the method of clustering keywords on a computer.

Additional aspects of example embodiments will be set forth in part in the description which follows and, in part, will be apparent from the description, or may be learned by practice of the disclosure.

According to example embodiments, it is possible for an electronic device to identify at least one vector corresponding to each of at least one target keyword using a text set including unstructured data related to finance, such as economic news. It is possible for the electronic device to identify a similarity between the at least one target keyword based on the at least one vector. It is possible for the electronic device to identify at least one set including at least some of the at least one target keyword by clustering target keywords with a high similarity.

According to example embodiments, it is possible for the electronic device to automatically cluster stocks with high degrees of mutual association and to provide a clustered set of stocks to a user. In addition, according to example embodiments, it is possible for the electronic device to change a combination of stocks to be clustered in real time by applying social events or an issue of a specific company in real time based on text content such as news that is generated in real time. In addition, according to example embodiments, it is possible to provide the user with a representative keyword that is currently considered an issue through the stock market and a list of stocks related to the keyword.

Effects of the present disclosure are not limited to those described above, and other effects may be made apparent to those skilled in the art from the following description.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

These and/or other aspects, features, and advantages of the disclosure will become apparent and more readily appreciated from the following description of example embodiments, taken in conjunction with the accompanying drawings of which:

FIG. 1 shows a system according to an example embodiment;

FIG. 2 is a flowchart showing a method of clustering keywords;

FIGS. 3 and 4 show examples of text data and text elements included in a text set according to an example embodiment;

FIGS. 5 and 6 are diagrams for explaining a co-occurrence graph generated based on a keyword set and the total number of times that keywords appear according to an example embodiment;

FIG. 7A is a diagram for explaining a weighted co-occurrence graph generated based on a keyword set, the total number of times that keywords appear, and a first weight according to an example embodiment;

FIG. 7B is a diagram for explaining a co-occurrence graph according to another example embodiment;

FIG. 7C illustrates diagrams for explaining a directed weighted co-occurrence graph generated based on a keyword set and the total number of times that keywords appear;

FIG. 7D is a diagram for explaining a directed weighted co-occurrence graph in which a degree of association of a keyword pair is indicated;

FIG. 8 is a diagram for explaining a co-occurrence matrix corresponding to a co-occurrence graph, a weighted co-occurrence graph, or a directed weighted co-occurrence graph;

FIG. 9 is a diagram for explaining a method of identifying a similarity between at least one target keyword based on at least one vector;

FIG. 10 shows a dendrogram according to hierarchical clustering using a similarity between at least one target keyword;

FIG. 11 is a flowchart for explaining a method of identifying a target keyword that is simultaneously included in a plurality of sets according to an example embodiment;

FIG. 12 is a diagram for explaining a result from clustering at least one target keyword into at least one set;

FIG. 13 is a flowchart showing a method of determining a sort order of information about at least one set according to an example embodiment;

FIGS. 14 and 15 are diagrams according to an example embodiment in which information about at least one set is displayed on a terminal;

FIGS. 16 and 17 are flowcharts showing various preprocessing methods of text data related to filtering text elements corresponding to a set type; and

FIG. 18 shows a block diagram of an electronic device according to an example embodiment.

### DETAILED DESCRIPTION

Terms used in the example embodiments are selected from currently widely used general terms when possible while considering the functions in the present disclosure. However, the terms may vary depending on the intention or precedent of a person skilled in the art, the emergence of new technology, and the like. Further, in certain cases, there are also terms arbitrarily selected by the applicant, and in the cases, the meaning will be described in detail in the corresponding descriptions. Therefore, the terms used in the present disclosure should be defined based on the meaning of the terms and the contents of the present disclosure.

Throughout the specification, when a part is described as “comprising or including” a component, it does not exclude another component but may further include another component unless otherwise stated. Furthermore, terms such as “ . . . unit,” “ . . . group,” and “ . . . module” described in the specification mean a unit that processes at least one function or operation, which may be implemented as hardware, software, or a combination thereof.

Expression “at least one of a, b, and c” described throughout the specification may include “a alone,” “b alone,” “c alone,” “a and b,” “a and c,” “b and c” or “all of a, b, and c.”

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

Hereinafter, example embodiments of the present disclosure will be described in detail with reference to the accompanying drawings.

In describing the example embodiments, descriptions of technical contents that are well known in the technical field to which the present disclosure pertains and that are not directly related to the present disclosure will be omitted. This is to more clearly convey the gist of the present disclosure without obscuring the gist of the present disclosure by omitting unnecessary description.

For the same reason, some elements are exaggerated, omitted, or schematically illustrated in the accompanying drawings. In addition, the size of each element does not fully reflect the actual size. In each figure, the same or corresponding elements are assigned the same reference numerals.

Advantages and features of the present disclosure, and a method of achieving the advantages and the features will become apparent with reference to the example embodiments described below in detail together with the accompanying drawings. However, the present disclosure is not limited to the example embodiments disclosed below and may be implemented in various different forms. The example embodiments are provided only so as to render the present disclosure complete and completely inform the scope of the present disclosure to those of ordinary skill in the art to which the present disclosure pertains. Like reference numerals refer to like elements throughout.

In this case, it will be understood that each block of a flowchart diagram and a combination of the flowchart diagrams may be performed by computer program instructions. The computer program instructions may be embodied in a processor of a general-purpose computer or a special purpose computer or may be embodied in a processor of other programmable data processing equipment. Thus, the instructions, executed via a processor of a computer or other programmable data processing equipment, may generate a part for performing functions described in the flowchart blocks. To implement a function in a particular manner, the computer program instructions may also be stored in a computer-usable or computer-readable memory that may direct a computer or other programmable data processing equipment. Thus, the instructions stored in the computer usable or computer readable memory may be produced as an article of manufacture containing an instruction part for performing the functions described in the flowchart blocks. The computer program instructions may be embodied in a computer or other programmable data processing equipment. Thus, a series of operations may be performed in a computer or other programmable data processing equipment to create a computer-executed process, and the computer or other programmable data processing equipment may provide steps for performing the functions described in the flowchart blocks.

Additionally, each block may represent a module, a segment, or a portion of code that includes one or more executable instructions for executing a specified logical function(s). It should also be noted that in some alternative implementations the functions recited in the blocks may occur out of order. For example, two blocks shown one after another may be performed substantially at the same time, or the blocks may sometimes be performed in the reverse order according to a corresponding function.

In the present disclosure, a text set may be a set of unstructured data related to finance. Further, text data in the text set may be unstructured data related to finance. The finance-related unstructured data may include finance-related text data, and the finance-related unstructured data may include at least one of finance-related news or finance-related blogs. In addition to the finance-related text data exemplified above, the finance-related unstructured data may include various types of finance-related text data distributed through Internet networks. In various example embodiments, the text set may not include certain types of finance-related unstructured data. For example, finance-related text data including content-content that simply lists multiple stocks with low mutual degrees of association—that is irrelevant to the correlation among the multiple stocks may be filtered out from being included in the text set. For example, market news simply lists information about the stock list and the rate of return for each stock within the stock list, and thus, it may be inappropriate to classify stocks included in market news as related stocks. Similarly, it may be inappropriate to classify stocks included in advertising news related to financial products as related stocks. In other words, the finance-related unstructured data including at least one of market news or advertising news may be filtered and not be included in the text set. In the present disclosure, it is explained that the content related to the text set includes unstructured data related to finance, but it is not limited thereto. It may be similarly applied to text sets including unstructured data related to specific fields other than the finance.

In the present disclosure, a text element may refer to a sentence within unstructured data related to finance. In various example embodiments, among sentences in unstructured data related to finance, certain types of sentences may not correspond to a text element. For example, among sentences in finance-related unstructured data, sentences that correspond to a set type may be filtered, and only the remaining unfiltered sentences may correspond to the text elements. For example, the set type of sentence may be a sentence including at least one of a phrase related to market conditions or a phrase related to advertising.

In the present disclosure, a keyword is an important word within a text element, and the keyword may refer to an important word identified or extracted within at least one text element through various means, such as a NER model, a morpheme analysis model, and user settings. For example, the keyword may be an important word related to finance within the at least one text element. Further, a keyword set may indicate a set of important words within the at least one text element. For example, the keyword set may be a set of important words related to finance within the at least one text element. The keyword set may include one or more keywords.

Each keyword included in the keyword set may be classified as either a target keyword or a general keyword depending on whether the keyword is a stock name or financial product name listed on a specific exchange.

A target keyword may indicate a keyword corresponding to a stock name or a financial product name listed on a specific exchange among keywords included in the keyword set. Further, a target keyword set may refer to a set of keywords corresponding to stock names listed on a specific preset exchange or a set of keywords corresponding to the same type of financial product name. For example, when the target keyword set is a set of stocks listed on the Korean exchange, the target keyword may be a stock name of a company listed on one of “Korea Composite Stock Price Index (KOSPI) market,” “Korean Securities Dealers Automated Quotations (KOSDAQ) market,” and “Korea New Exchange (KONEX) market” among keywords within the at least one text element. Further, when the target keyword set is a set of stocks listed on a specific virtual asset exchange, the target keyword may be one of the names of virtual assets listed on a specific virtual asset exchange, such as “Bitcoin” and “Ethereum,” among keywords within the at least one text element. In the present disclosure, it is explained that the target keyword includes a stock name and/or a virtual asset name, but it is not limited thereto. The target keywords may be names of various financial products such as “raw materials,” “corporate bonds,” and “government bonds.” Further, the target keyword set that is preset may be updated periodically. For example, as new stocks are listed or existing stocks are delisted on a specific exchange, stocks listed on the specific exchange may be updated, and accordingly, the keyword set may be updated.

A general keyword may refer to a keyword included in the keyword set that is neither a stock name nor a financial product name listed on the specific exchange. In other words, the general keyword may be any keyword included in the keyword set, excluding the target keyword. For example, among keywords included in the keyword set, “semiconductor” is neither a stock name nor a financial product name listed on a specific exchange, and thus, the word may be classified as a general keyword.

Depending on how the electronic device identifies or extracts keywords from text elements, each keyword included in the keyword set may be classified as one of a first keyword, a second keyword, and a third keyword. However, the present disclosure is not limited thereto, and keyword types may be added or omitted depending on how keywords are identified or extracted.

The first keyword is a keyword included in a sentence in finance-related unstructured data and may be identified through a NER model. In an example embodiment, the NER model may be a model based on deep learning. The NER model may be a model that can recognize entities with names that refer to specific objects within specified text.

The second keyword may be a keyword included in a predetermined financial keyword set among keywords of a set word class included in sentences within finance-related unstructured data identified through morpheme analysis. Here, the set word class may be a noun. Further, the predetermined financial keyword set may be a dictionary composed of preset important finance-related words. Here, the important finance-related words may be major market indices such as “interest rate” and “exchange rate.” Further, the predetermined financial keyword set may include important words related to finance that are relatively recent, such as “Bitcoin” and “Metaverse.” These recently generated important words related to finance may not be well identified through a named entity model, and thus, such words may be identified as a second keyword by setting the words to be included in the financial keyword set.

The third keyword may be a keyword of which frequency of appearance in the latest text data is increased rapidly. More specifically, among the keywords of a set word class included in sentences in finance-related unstructured data identified through morpheme analysis, a third keyword may be a keyword that is not included in the set financial keyword set but is detected to have a sharp increase in the frequency of appearance in the latest text data. If the frequency of a specific word appearing in a text element included in recently generated text data increases rapidly, the specific word may be identified as a third keyword. For example, if a particular presidential candidate makes a hot topic by announcing a pledge related to “hair loss” prior to the presidential election, the number of economic news stories with “hair loss” as a keyword may increase rapidly during a certain period, for example, within the past month. In this case, since “hair loss” is generally a word with a low financial degree of association, it may not be set to be included in the financial keyword set and may not be identified as a second keyword. However, “hair loss” may be identified as a third keyword because “hair loss” is detected to have a sharp increase in the frequency of its appearance recently. Because of this, when the frequency of appearance of a specific word rapidly increases as an important event occurs, the specific word may be quickly incorporated into the keyword set by being identified as a third keyword.

Hereinafter, example embodiments of the present disclosure will be described in detail with reference to the drawings.

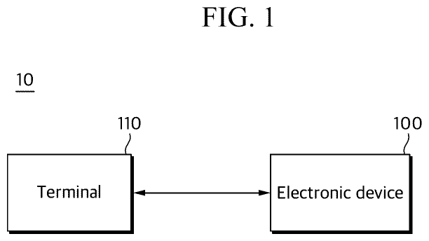

FIG. 1 shows a system according to an example embodiment.

Referring to FIG. 1, a system 10 according to various example embodiments may be implemented by various types of devices. For example, the system 10 may include an electronic device 100 and a terminal 110. Those skilled in the art can understand that other general-purpose elements may be included in addition to the elements illustrated in FIG. 1.

According to an example embodiment, the electronic device 100 may identify a text set including at least one text element. Here, the text set may be a set of finance-related unstructured data stored in a memory within the electronic device 100 or stored on a server (not illustrated). The electronic device 100 may identify keywords within the at least one text element. The keywords within the at least one text element may include a first keyword identified through a deep learning-based NER model and a second keyword or a third keyword that is a keyword of a set word class in the at least one text element which is identified with morpheme analyzing.

According to an example embodiment, the electronic device 100 may identify a keyword set including a keyword within at least one text element. The electronic device 100 may identify a keyword that is included in both the keyword set and a target keyword set that is set as at least one target keyword related to the text set. Each keyword included in the keyword set may be classified as either a target keyword or a general keyword depending on whether the keyword is a stock name or financial product name listed on a specific exchange. Among keywords included in the keyword set, a keyword that is not included in the target keyword set may be classified as a general keyword.

According to an example embodiment, the electronic device 100 may identify at least one vector corresponding to each of the at least one target keyword. The at least one vector may have elements identified based on a degree of association between the at least one target keyword and each of keywords included in the keyword set. In addition, the degree of association may be identified based on the text set.

In the present disclosure, a vector corresponding to a target keyword may include a plurality of elements, and each of the plurality of elements may be values indicating degrees of association between the target keyword and other keywords. In other words, a value of an element corresponding to any keyword among elements of a vector corresponding to a target keyword may indicate a degree of association between the target keyword and the any keyword. The value of the element corresponding to the any keyword among elements of the vector corresponding to the target keyword may be based on the total number of times that the target keyword and the any keyword are included together in each of at least one text element. For example, for a vector corresponding to a specific target keyword, an element corresponding to a keyword with a relatively high frequency of appearing together with the specific target keyword in at least one text element may have a relatively high value. Conversely, an element corresponding to a keyword with a relatively low frequency of appearing together with the specific target keyword in at least one text element may have a relatively low value.

According to an example embodiment, the electronic device 100 may identify a similarity between at least one target keyword based on at least one vector that is identified. In the present disclosure, a similarity between target keywords may be a value determined based on the frequency of the target keywords appearing in text elements contextually similar to each other. For example, the target keywords may include a first target keyword and a second target keyword. In this case, the high frequency of the first target keyword and the second target keyword appearing in text elements contextually similar to each other may indicate that the first target keyword and the second target keyword appear in text elements together with keywords of a first group in high frequency and appear in text elements together with keywords of a second group other than keywords of the first group in low frequency. In this case, a similarity between the first target keyword and the second target keyword may have a high value. Conversely, the low frequency of the first target keyword and the second target keyword appearing in text elements contextually similar to each other may indicate that the first target keyword appears in text elements together with keywords of the first group in high frequency and appears in text elements together with keywords of the second group in low frequency, while the second target keyword appears in text elements together with keywords of the second group in high frequency and appears in text elements together with keywords of the first group in low frequency. In this case, the similarity between the first target keyword and the second target keyword may have a low value.

According to an example embodiment, the electronic device 100 may identify at least one set including at least some of at least one target keyword by clustering the at least one target keyword based on a similarity between the at least one target keyword. The electronic device 100 may repeatedly perform the operation of clustering target keyword pairs with high similarities into identical sets, based on similarities between target keyword pairs each consisting of any two target keywords. By repeatedly performing the operation of clustering target keyword pairs, the electronic device 100 may cluster at least one target keyword into at least one set. Each of the at least one set may include at least one of the at least one target keyword, and a similarity between target keywords included in an identical set may be relatively high.

According to an example embodiment, the electronic device 100 may generate information about at least one set. The electronic device 100 may transmit information about at least one set to the terminal 110. Accordingly, the terminal 110 may receive information about the at least one set from the electronic device 100. The terminal 110 may receive a user input through an input interface and may transmit an output corresponding to the user input to the electronic device 100 through an output interface or display the output on a screen of the terminal 110. For example, when the user input is an input related to a first set among the at least one set, detailed information about the first set may be displayed on the screen of the terminal 110. The detailed information about the first set may include information about text elements or text data including at least some of target keywords included in the first set. Alternatively, the detailed information about the first set may include information about at least one subset included in the first set. Alternatively, the detailed information about the first set may include information about a representative keyword for the first set. A representative keyword may indicate a keyword with a high degree of association with each of the target keywords included in a set. In addition to the information about the representative keyword about the first set, information about a representative keyword for each of the at least one subset included in the first set may also be included in the detailed information about the first set. For example, when a representative keyword of a set is “semiconductor,” the representative keyword for each of at least one subset included in the set may be identified as “fabless,” “foundry,” and “packaging.” In this case, “semiconductor,” “fabless,” “foundry,” and “packaging” may be included in the detailed information about the first set.

Each of the electronic device 100 and the terminal 110 may include a memory and a processor. Further, each of the electronic device 100 and the terminal 110 refers to a unit that processes at least one function or operation, and this may be implemented through hardware, software, or a combination of hardware and software. Meanwhile, throughout the present disclosure, each of the electronic device 100 and the terminal 110 is referred to as a physically separate device or server but may have a logically divided structure, and at least some of these may be implemented as separate functions on a single device or server.

According to an example embodiment, the electronic device 100 and the terminal 110 may include a number of computer systems or computer software implemented as network servers. For example, at least one of the electronic device 100 and the terminal 110 may refer to a computer system and computer software that is connected to subordinate devices that can communicate with other network servers over a computer network, such as an intranet or the Internet, to receive requests to perform tasks, and performs operations thereof and provides results. In addition thereto, at least one of the electronic device 100 and the terminal 110 may be understood as a broad concept including a series of applications that can run on a network server and various databases built internally or on other connected nodes. For example, at least one of the electronic device 100 and the terminal 110 may be implemented using network server programs that are provided in various ways depending on the operating system, such as DOS, Windows, Linux, UNIX, or MacOS.

The electronic device 100 and the terminal 110 may communicate with each other through a network (not illustrated). Networks include local area networks (LAN), wide area networks (WAN), value added networks (VAN), mobile radio communication networks, satellite communication networks, and combinations thereof. The networks are comprehensive data communication networks that allow each network constituent illustrated in FIG. 1 to communicate smoothly with each other. The networks may include wired Internet, wireless Internet, and mobile wireless networks. Wireless communications may include, for example, wireless LAN (Wi-Fi), Bluetooth, Bluetooth low energy, ZigBee, Wi-Fi Direct (WFD), ultra-wideband (UWB), infrared data association (IrDA), and near field communication (NFC), but the wireless communications are not limited thereto.

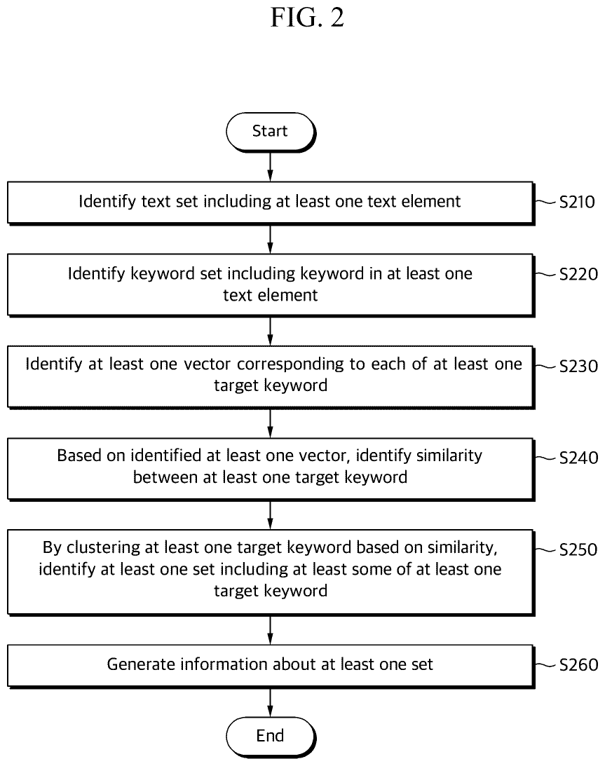

FIG. 2 is a flowchart showing a method of clustering keywords.

Referring to FIG. 2, within the scope of what is clearly understood by those skilled in the art to which the present disclosure pertains, it is apparent that for each operation in which an electronic device clusters keywords, some operations may be changed or replaced, or some sequences between operations may be changed.

In operation S210, the electronic device may identify a text set including at least one text element.

The text set may be a set of unstructured data related to finance. The text set may be a text set including text data generated within a set period of time. Time when the text data is generated may be one of the time that the text data was first generated and the time that the text data was last modified. Further, the text element may correspond to one of sentences included in the finance-related unstructured data.

In operation S220, the electronic device may identify a keyword set including a keyword in at least one text element. The keyword set may include at least one target keyword.

The keyword included in the keyword set may include a first keyword identified through the deep learning-based NER model. According to various example embodiments, keywords identified within at least one text element by the electronic device 100 may further include at least one of a second keyword and a third keyword in addition to the first keyword. The second keyword or the third keyword may be a keyword of a set word class within at least one text element identified through morpheme analysis. The first keyword, the second keyword, or the third keyword may be classified according to the way the electronic device identifies or extracts the keyword within the text element.

The first keyword is a keyword corresponding to a named entity in at least one text element and may be identified through a NER model based on deep learning. Here, the named entity may represent a term that refers to a specific object. For example, a term referring to a specific object, such as a specific person, a specific region, a specific organization, or a specific country, may be a named entity. Further, the NER model according to one example embodiment may be trained based on big data in Korean, but keywords in the present disclosure are not limited to Korean. In other words, in the present disclosure, the NER model may be trained based on big data in various languages, including English, Chinese, and Japanese in addition to Korean, and keywords of the present disclosure according thereto may include keywords in various languages.

As named entities within text elements are identified through the NER model based on deep learning, new words that appear less frequently in text data, long words, and mixed words may also be classified as first keywords. Further, named entities within text elements and categories for each named entity may also be identified through the NER model based on deep learning. For example, when “Keyword A” is a homonym and can mean both a name of a region and a name of an organization, by analyzing the context of the text element including “Keyword A,” the electronic device 100 may classify “Keyword A” differently into “Keyword A” in a “region” category and “Keyword A” in an “organization” category.

The second keyword may be a keyword included in a predetermined financial keyword set among the keywords of a set word class included in sentences in finance-related unstructured data identified through morpheme analysis. Here, the set word class may be a noun. Further, the predetermined financial keyword set may be a dictionary composed of preset important finance-related words. The finance-related keywords may not be named entities but may be words that need to be identified as finance-related keywords. For example, keywords related to finance may include major indices or financial terms in the financial market, such as “interest rate,” “exchange rate,” “acquisition,” and “acquired.”

The third keyword may be a keyword of which frequency of appearance in the latest text data is increased rapidly. More specifically, the third keyword may be a keyword that is not included in the predetermined financial keyword set but has a sharp increase in the frequency of appearance in the latest text data, among the keywords of a set word class included in sentences in finance-related unstructured data identified through morpheme analysis.

Each keyword identified within at least one text element may be classified as either a target keyword or a general keyword depending on whether the keyword is a stock or financial product listed on a specific exchange. In other words, if the keyword identified is the stock or financial product listed on a specific exchange, the keyword may be classified as a target keyword, but other than that, may be classified as a general keyword. According to an example embodiment, if the keyword identified is included in a target keyword set that is preset, the corresponding keyword may be classified as a target keyword. A target keyword set may include a keyword classified as a target keyword among the keywords within at least one text element. For example, if the keyword is the stock name of a company listed on one of the “KOSPI market,” “KOSDAQ market,” and “KONEX market” among the keywords within at least one text element, the keyword may be classified as a target keyword corresponding to the stock listed on one of the Korean exchange markets. Further, based on that the stock name of a company listed on one of the “KOSPI market,” “KOSDAQ market,” and “KONEX market” is a named entity and is identified by the NER model based on deep learning, the keyword may be both the first keyword and the target keyword. Further, for example, if the keyword is “interest rate,” a major finance-related word, the keyword may be both the second keyword and the general keyword.

When the keyword is a homonym, the electronic device 100 may analyze the context of the text element including the keyword and thus may determine the keyword to be one of multiple homonyms. When a specific keyword refers to a stock listed on a specific exchange among multiple homonyms, the specific keyword may be classified as a target keyword. When the specific keyword has a meaning other than a stock or a financial product listed on a specific exchange among multiple homonyms, the specific keyword may be classified as a general keyword.

According to an example embodiment, the electronic device 100 may further identify categories for each of keywords within at least one text element. More specifically, for each identified keyword within the at least one text element, the electronic device 100 may identify a keyword category among a plurality of preset categories. Here, some of the plurality of preset categories may be “Person,” “Location,” “Organization,” “Artifact,” “Date,” “Time,” “Country,” “Animal,” “Plant,” “Quantity,” “Study-field,” “Theory,” “Event,” “Material,” “Term,” and “Custom dictionary,” but the category is not limited thereto. For example, some of the listed categories may be omitted, or not listed additional categories may be added. Here, among the plurality of categories, the user-specified dictionary or “Custom dictionary” may be a category corresponding to a second keyword or a third keyword.

In operation S230, the electronic device may identify at least one vector corresponding to each of at least one target keyword.

The at least one vector may have elements identified based on a degree of association between the at least one target keyword and each of keywords included in the keyword set. In addition, the degree of association may be identified based on the text set.

The electronic device 100 may identify the total number of times that keyword pairs each consisting of any two keywords included in the keyword set are included together in each of at least one text element. The degree of association of a keyword pair having a combination of any one of the keywords included in the keyword set and any one of at least one target keyword may be based on the total number of times that the keyword pairs are included together in each of the at least one text element. According to an example embodiment, for any first target keyword, the electronic device 100 may identify the number of times that the first target keyword and each of n number of other keywords included in the keyword set are included together in at least one text element.

In this case, for the first target keyword, the electronic device 100 may identify information about a first vector including degrees of association with other keywords included in the keyword set. For example, the first vector corresponding to the first target keyword may include n number of elements corresponding to n number of other keywords, and each of the n number of elements may be identified based on the total number of times that the first target keyword and each of n number of other keywords are included together in at least one text element. In various example embodiments, when any two vectors different from each other that are, for example, a first vector and a second vector include n number of elements each, an ith element of the first vector and an ith element of the second vector may be an element corresponding to the identical keyword. In other words, the ith element of the first vector corresponding to the first target keyword may be based on the total number of times that the first target keyword and an ith keyword are included together in at least one text element, and the ith element of the second vector corresponding to a second target keyword may be based on the total number of times that the second target keyword and an ith keyword are included together in at least one text element.

According to an example embodiment, prior to determining elements of a vector corresponding to a target keyword, the electronic device 100 may identify a co-occurrence graph to determine degrees of association between the target keyword and other keywords. The electronic device 100, based on the co-occurrence graph, may determine the degrees of association between the target keyword and other keywords and may determine the elements of the vector corresponding to the target keyword.

According to an example embodiment, the electronic device 100 may determine a co-occurrence graph based on a keyword set and the total number of times that keywords appear. The co-occurrence graph may include nodes and an edge connecting the nodes. Each of the nodes may correspond to one of the keywords included in the keyword set. A weight of the edge may be identified based on a total number of times that two keywords corresponding to each of a first node and a second node that are connected to the edge are included together in each of at least one text element.

According to an example embodiment, before determining the co-occurrence graph, the electronic device 100 may first identify keyword pairs each consisting of any two keywords included in the keyword set. According to an example embodiment, the electronic device 100 may first identify a sub keyword set within the keyword set and may identify keyword pairs each consisting of any two keywords included in the sub keyword set. For each text element, the sub keyword set may be understood as a set of keywords that are simultaneously included within each text element. When a sub keyword set is first identified and degrees of association of keyword pairs each consisting of any two keywords included in the sub keyword set are determined, computational efficiency may be increased, when compared to the case where degrees of association of keyword pairs each consisting of any two keywords included in a keyword set are determined.

According to an example embodiment, the co-occurrence graph may further include information about a modified degree of association of a keyword pair based on a generation time of text data, and the co-occurrence graph may be referred to as a weighted co-occurrence graph. The weighted co-occurrence graph may include nodes and an edge connecting the nodes. Each of the nodes may correspond to one of the keywords included in the keyword set. A weight of the edge may correspond to a total number of times that two keywords corresponding to each of a first node and a second node that are connected to the edge are included together in each of at least one text element or a modified total number of times that is identified based on a first weight corresponding to a generation time of text data including at least one text element.

According to an example embodiment, the co-occurrence graph may further include information on the direction of the degree of association of the keyword pair, and the co-occurrence graph may be referred to as a directed weighted co-occurrence graph. The directed weighted co-occurrence graph may also include nodes and edges. The node may be understood as representing each keyword, and the edge is expressed as a line connecting two nodes and may be understood as indicating that two keywords corresponding to the two nodes are included together in one text element. Regarding a first node and a second node connecting to an edge, the weight of an edge in the directed weighted co-occurrence graph may be based on a first sub weight from the first node to the second node or a second sub weight from the second node to the first node. With regard thereto, the degree of association of the keyword pair may be determined through a predetermined calculation by using the first sub weight or the second sub weight between two nodes corresponding to the keyword pair in the directed weighted co-occurrence graph. For example, the predetermined calculation may be multiplying the first sub weight by the second sub weight.

In operation S240, based on the identified at least one vector, the electronic device may identify a similarity between at least one target keyword.

According to an example embodiment, the similarity between at least one target keyword may be determined based on a cosine similarity between at least one vector corresponding to the at least one target keyword. Here, a cosine similarity between a first vector and a second vector may be a value obtained by dividing the inner product of the first vector and the second vector by the product of a size of the first vector and a size of the second vector and may be a numerical value of how similar a direction of the first vector and a direction of the second vector are. As a first target keyword and a second target keyword appear in text elements contextually similar to each other in higher frequency, the similarity between the first target keyword and the second target keyword may be higher. Conversely, as a first target keyword and a second target keyword appear in text elements contextually similar to each other in lower frequency, the similarity between the first target keyword and the second target keyword may be lower.

For example, the number of times that each of the first target keyword and the second target keyword appears together with keywords of a first group in at least one text element within the text set may be relatively high, and the number of times that each of the first target keyword and the second target keyword appears together with keywords of a second group in at least one text element within the text set may be relatively low. In this case, the first target keyword and the second target keyword may be identified as similar keywords that appear in contextually similar text elements in high frequency, and a value of a cosine similarity between the first vector corresponding to the first target keyword and the second vector corresponding to the second target keyword may be calculated as large.

For another example, the number of times that the first target keyword appears together with keywords of the first group in at least one text element within the text set may be relatively high, and the number of times that the first target keyword appears together with keywords of the second group in at least one text element within the text set may be relatively low. Meanwhile, the number of times that the second target keyword appears together with keywords of the second group in at least one text element within the text set may be relatively high, and the number of times that the second target keyword appears together with keywords of the first group in at least one text element within the text set may be relatively low. In this case, the first target keyword and the second target keyword may be identified as dissimilar keywords that appear in contextually similar text elements in low frequency, and the value of the cosine similarity between the first vector corresponding to the first target keyword and the second vector corresponding to the second target keyword may be calculated as small.

However, identifying a similarity between at least one target keyword is not limited to identifying a similarity between at least one target keyword based on a cosine similarity between at least one vector. The electronic device 100 may also identify a similarity between at least one target keyword based on at least one of Euclidean distance, Mahalanobis distance, and Minkowski distance between at least one vector.

In operation S250, by clustering at least one target keyword based on the similarity, the electronic device may identify at least one set including at least some of at least one target keyword.

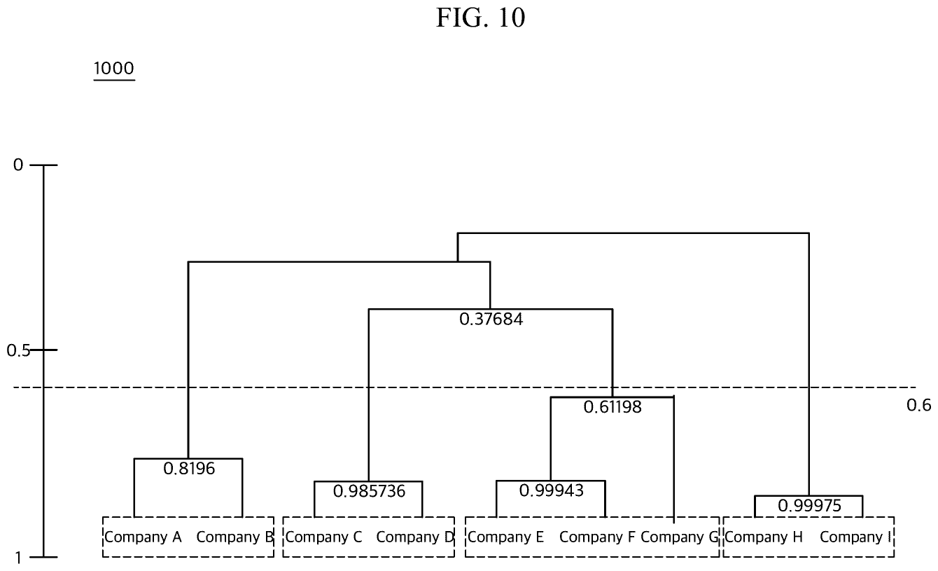

According to an example embodiment, by performing hierarchical clustering using a similarity between at least one vector, the electronic device 100 may identify at least one set including at least some of at least one target keyword. The total number of at least one set is appropriately determined based on a dendrogram according to hierarchical clustering and a set value and thus may not be a fixed value. An example embodiment in which the total number of at least one set is determined based on a dendrogram according to hierarchical clustering will be described with reference to FIG. 10.

In operation S260, the electronic device may generate information about at least one set.

According to an example embodiment, information about at least one set may include information about a target keyword included in each of the at least one set and a rate of return for each target keyword, information about at least one average rate of return corresponding to the at least one set, and information about a representative keyword of each of the at least one set.

The text set in operation S210 may include text data generated within a set period of time (for example, 6 months or 1 year). The electronic device 100 may generate information about at least one set based on the text set including the text data generated within the set period of time. In this case, an important social event or an issue for each company that occurred within the set period of time may be reflected in the information about at least one set. Therefore, a user of the terminal 110 may easily identify a set (for example, a set with the highest average rate of return) representing trends in the financial market within a set period of time, a representative keyword of the set, and at least one target keyword included in the set. For example, as media coverage is focused on news related to artificial intelligence (AI) technology within the set period of time, the electronic device 100 may identify a first set whose representative keyword is AI. Accordingly, the user of the terminal 110 may easily identify that stocks included in the first set are stocks related to AI.

As new text data continues to be uploaded, the text set may also be periodically updated. The electronic device 100 may perform again the operation of clustering keywords with a high similarity into an identical set based on the updated text set. Accordingly, at least one set and a list of target keywords included in each of the at least one set may also be changed. For example, according to the occurrence of an important event (for example, credit risk), when news data related to an important event rapidly increases, the electronic device 100 may generate information about a set related to the important event including information (for example, banking company stocks) about a target keyword related to the important event and information (for example, credit risk) about a representative keyword. In addition, the target keyword set may include keywords corresponding to stocks listed on a specific exchange and thus may be updated, in response to that a company listed on a specific exchange is delisted or a new company is listed. Accordingly, in response to that the target keyword set is updated, at least one target keyword may be updated to further include a new target keyword included in the updated target keyword set among the keywords included in the keyword set.

The text set is not limited to one text set. For example, the text set may be a plurality of text sets including each text data generated within a plurality of set periods of time (for example, 6 months, 2 years, or 10 years). For example, the text set may include a first text set generated within 6 months from a current time point, a second text set generated within 2 years from a current time point, or a third text set generated within 10 years from a current time point. Accordingly, based on the plurality of text sets, the electronic device 100 may perform the operation of clustering keywords a plurality of times. Therefore, the user of the terminal 110 may easily identify the change history of a set including each of at least one target keyword. In addition, the user of the terminal 110 may easily identify the change history of a representative keyword of the set including each of at least one target keyword.

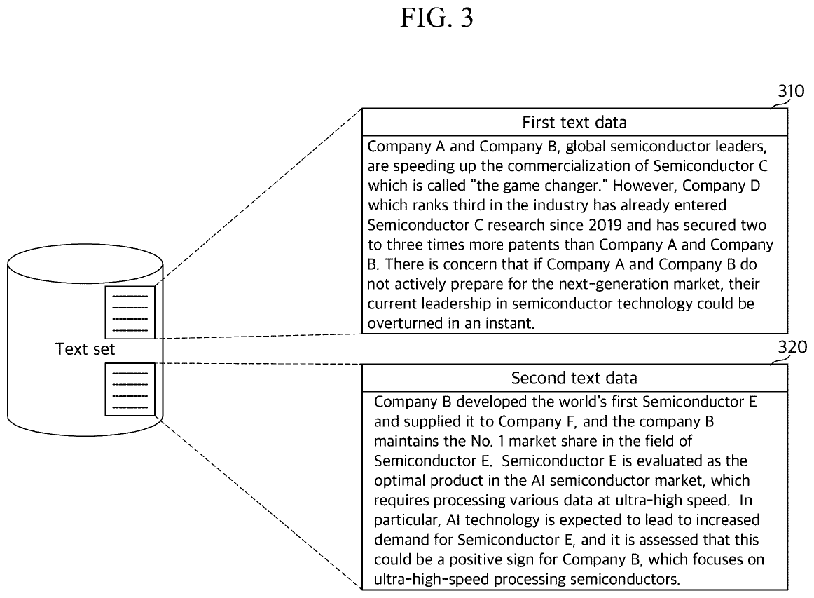

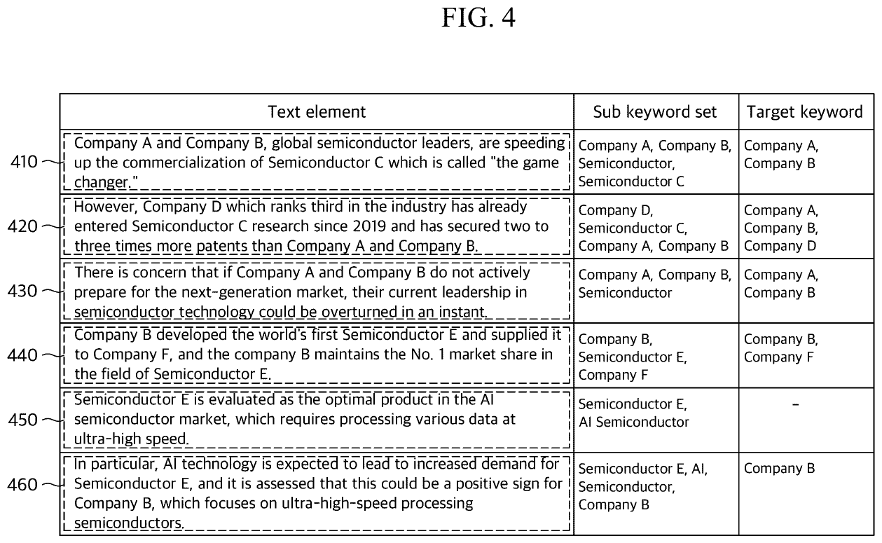

FIGS. 3 and 4 show examples of text data in a text set and text elements included in the text data according to an example embodiment.

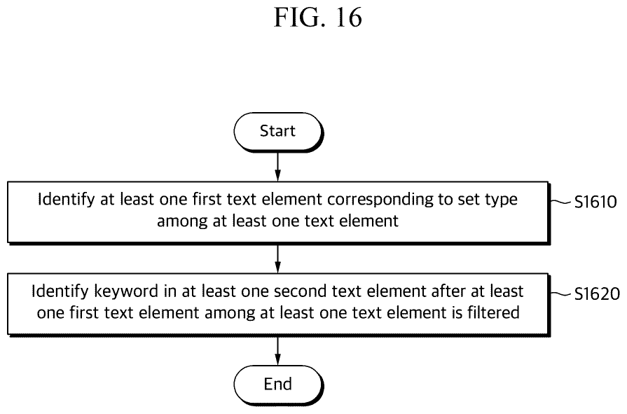

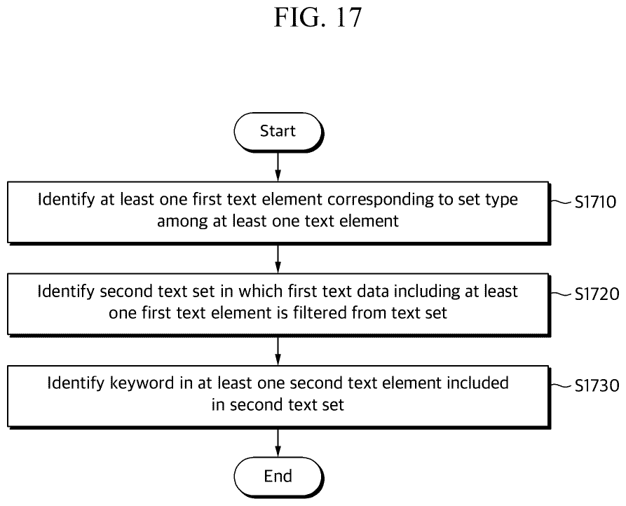

According to an example embodiment, the text set may include first text data 310 and second text data 320 in the finance-related unstructured data. Here, the finance-related unstructured data is finance-related text data, and the finance-related text data may include at least one of finance-related news or finance-related blogs. With regard thereto, the electronic device 100 may crawl finance-related unstructured data periodically or aperiodically from sites where finance-related unstructured data is uploaded. The first text data 310 and the second text data 320 in FIG. 3 represent parts of crawled text data. Meanwhile, in an example embodiment, text data subject to crawling may include news of specific categories, and for example, news included in the “Economy” category may be included. Further, in an example embodiment, crawled text data may be preprocessed before subsequent analysis. The crawled text data may be processed through preprocessing to exclude duplicate articles and identify texts that are actually mentioned more often. Details related to the preprocessing will be described with reference to FIGS. 16 and 17.

Text elements within the text data may be distinguished based on the period, which comes right after the final word. The first text data 310 may include three sentences which are a first text element 410, a second text element 420, and a third text element 430. Further, the second text data 320 may include three sentences which are a fourth text element 440, a fifth text element 450, and a sixth text element 460.

According to an example embodiment, for each of at least one text element, the electronic device 100 may identify keywords within text elements through a deep learning-based NER model or morpheme analysis model, and the electronic device 100 may classify the identified keywords into one of a first keyword, a second keyword, and a third keyword. Further, depending on whether an identified keyword is a stock or financial product listed on a specific exchange, the electronic device 100 may classify the identified keyword into a target keyword or a general keyword. A keyword set may consist of keywords within at least one text element. Referring to FIG. 3, a keyword set identified based on the text set may include keywords such as “Company A,” “Company B,” “Company D,” “Company F,” “Semiconductor,” “Semiconductor C,” “Semiconductor E,” “AI Semiconductor,” and “AI.” A keyword set may include at least one sub keyword set corresponding to at least one text element, and the sub keyword set may be composed of keywords within one corresponding text element. Further, the electronic device 100 may identify categories for each keyword within at least one text element.

The sub keyword set corresponding to the first text element 410 may be composed of keywords included in the first text element 410 which are “Company A,” “Company B,” “Semiconductor,” and “Semiconductor C.” More specifically, “Company A,” “Company B,” “Semiconductor,” and “Semiconductor C” are terms referring to specific objects identified through the NER model and may be first keywords. “Company A” and “Company B” may be named entities with a category of “Organization.” When “Company A” and “Company B” are stocks listed on a specific exchange, “Company A” and “Company B” are the first keywords and at the same time target keywords. Each of “Semiconductor” and “Semiconductor C” is used as a term referring to a specific material of which electrical conductivity is intermediate between that of a conductor and an insulator at room temperature or semiconductor used for a specific purpose called C. Thus, “Semiconductor” and “Semiconductor C” can be named entities with category “Material.” Since “Semiconductor” and “Semiconductor C” are not stocks listed on a specific exchange, “Semiconductor” and “Semiconductor C” may be the first keywords and general keywords.

According to an example embodiment, performing an operation similar to the operation of identifying keywords included in the first text element 410 through the NER model, the electronic device 100 may identify keywords included in each of the second text element 420, the third text element 430, the fourth text element 440, the fifth text element 450 and the sixth text element 460. Each identified keyword may be classified as either a target keyword or a general keyword depending on whether the keyword is a stock or financial product listed on a specific exchange. Each of the identified keywords may be classified into one of a first keyword, a second keyword, and a third keyword depending on how the keyword is identified or extracted from the electronic device 100.

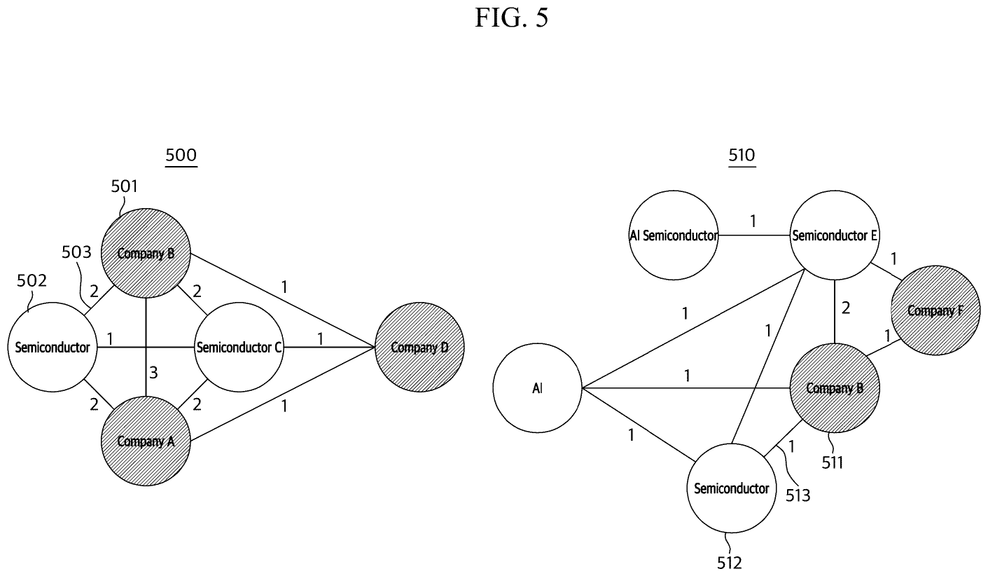

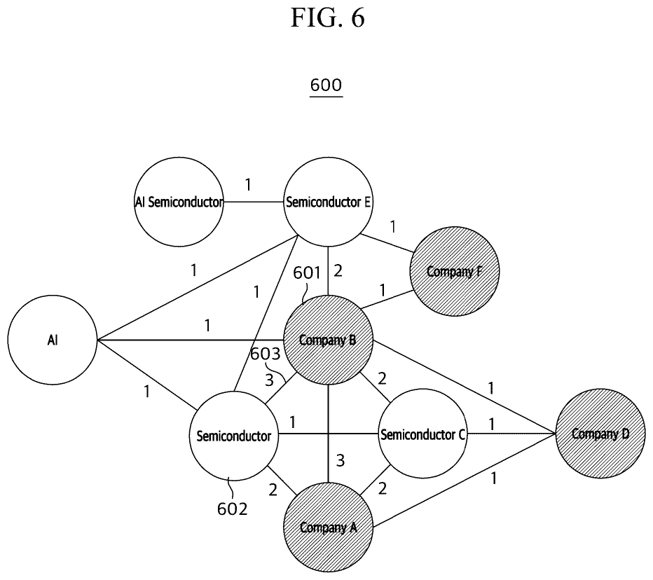

FIGS. 5 and 6 are diagrams for explaining a co-occurrence graph generated based on a keyword set and the total number of times that keywords appear according to an example embodiment.

According to an example embodiment, a node in a co-occurrence graph may correspond to one of the keywords included in the keyword set. Further, the weight of an edge in a co-occurrence graph may be the total number of times in which a keyword pair corresponding to two nodes connected to the edge is included together in at least one text element. Referring to FIGS. 5 and 6, among nodes in the co-occurrence graphs, nodes corresponding to a target keyword may be displayed as shaded on the co-occurrence graphs.

Referring to FIG. 5, a co-occurrence graph 500 may be a graph that is determined based on the first text element 410, the second text element 420, and the third text element 430 included in the first text data 310 illustrated in FIGS. 3 and 4. The keywords included in the first text data 310 may be “Company A,” “Company B,” “Company D,” “Semiconductor,” and “Semiconductor C.” Further, the target keywords included in the first text data 310 may be “Company A,” “Company B,” and “Company D.”

The first text element 410 may be “Company A and Company B, global semiconductor leaders, are speeding up the commercialization of Semiconductor C which is called ‘the game changer.’” Keywords in the first text element 410 may be “Company A,” “Company B,” “Semiconductor,” and “Semiconductor C.” The weights of the edges between a node corresponding to “Company A,” a node 501 corresponding to “Company B,” a node 502 corresponding to “Semiconductor,” and a node corresponding to “Semiconductor C” may be increased by 1 based on the first text element 410. As a similar operation is performed for the second text element 420 and the third text element 430, in the co-occurrence graph 500, the weights of the edges between nodes corresponding to the keywords in the second text element 420 and the third text element 430 may be cumulatively increased by 1. Accordingly, the co-occurrence graph 500 may be illustrated as shown in FIG. 5.

In an example embodiment, “Company B” and “Semiconductor” are not included together in the second text element 420 but may be included together in the first text element 410 and the third text element 430. The weight of an edge 503 between the node 501 corresponding to “Company B” and the node 502 corresponding to “Semiconductor” in the co-occurrence graph 500 may be 2. Except for the weight of the edge 503 in the co-occurrence graph 500, the weights of other edges may be similarly determined. For example, “Company A” and “Company B” may be target keywords included in all the first text element 410, the second text element 420, and the third text element 430. In other words, the weight of the edge between the node corresponding to “Company A” and the node corresponding to “Company B” may be calculated as 3, which is the total number of times that “Company A” and “Company B” are included in each of the first text element 410, the second text element 420, and the third text element 430.

Referring to FIG. 5, a co-occurrence graph 510 may be a graph determined based on the fourth text element 440, the fifth text element 450, and the sixth text element 460 included in the second text data 320. Keywords included in the second text data 320 may be “Company B,” “Company F,” “Semiconductor,” “Semiconductor E,” “AI Semiconductor,” and “AI.” Further, target keywords included in the second text data 320 may be “Company B” and “Company F.”

The sixth text element 460 may be “In particular, AI technology is expected to lead to increased demand for Semiconductor E, and it is assessed that this could be a positive sign for Company B, which focuses on ultra-high-speed processing semiconductors.” Keywords in the sixth text element 460 may be “Semiconductor E,” “AI,” “Semiconductor,” and “Company B.” The weights of edges between a node corresponding to “Semiconductor E,” a node corresponding to “AI,” a node 512 corresponding to “Semiconductor,” and a node 511 corresponding to “Company B” may be increased by 1 based on the sixth text element. As a similar operation is performed for the fourth text element 440 and the fifth text element 450, in the co-occurrence graph 510, the weights of the edges between nodes corresponding to the keywords in the fourth text element 440 and the fifth text element 450 may be cumulatively increased by 1. Accordingly, the co-occurrence graph 510 may be illustrated as shown in FIG. 5.

In an example embodiment, “Company B” and “Semiconductor” are included together in the sixth text element 460 but may not be included together in each of the fourth text element 440 and the fifth text element 450. Accordingly, the weight of an edge 513 between the node 511 corresponding to “Company B” and the node 512 corresponding to “Semiconductor” in the co-occurrence graph may be 1. Except for the weight of the edge 513 in the co-occurrence graph 510, the weights of other edges may be similarly determined. For example, “Company B” and “Semiconductor E” may be included in the fourth text element 440 and the sixth text element 460. In other words, the weight of the edge between the node 511 corresponding to “Company B” and the node corresponding to “Semiconductor E” may be calculated as 2, which is the total number of times that “Company B” and “Semiconductor E” are included in each of the fourth text element 440 and the sixth text element 460.

Referring to FIG. 6, a co-occurrence graph 600 may be a graph determined based on the first text element 410, the second text element 420, and the third text element 430 included in the first text data 310 and the fourth text element 440, the fifth text element 450, and the sixth text element 460 included in the second text data 320 illustrated in FIGS. 3 and 4.

According to an example embodiment, the weight of an edge in the co-occurrence graph may be the total number of times that a pair of keywords corresponding to two nodes connected to the edge are included together in at least one text element. For example, the weight of an edge 603 between a node 601 corresponding to “Company B” and a node 602 corresponding to “Semiconductor” in the co-occurrence graph 600 may be calculated as 3, which is the sum of 2, which is the weight of the edge 503 in the co-occurrence graph 500, and 1, which is the weight of the edge 513 in the co-occurrence graph 510. The weights of other edges in the co-occurrence graph 600 may also be identified following a similar process.

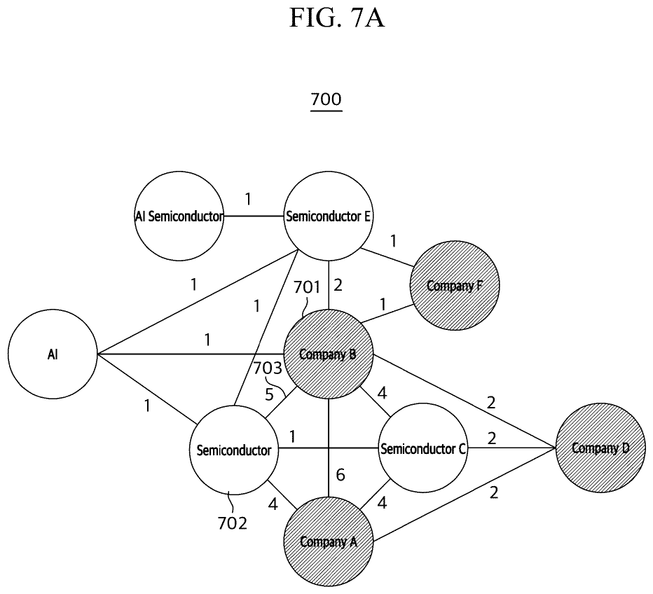

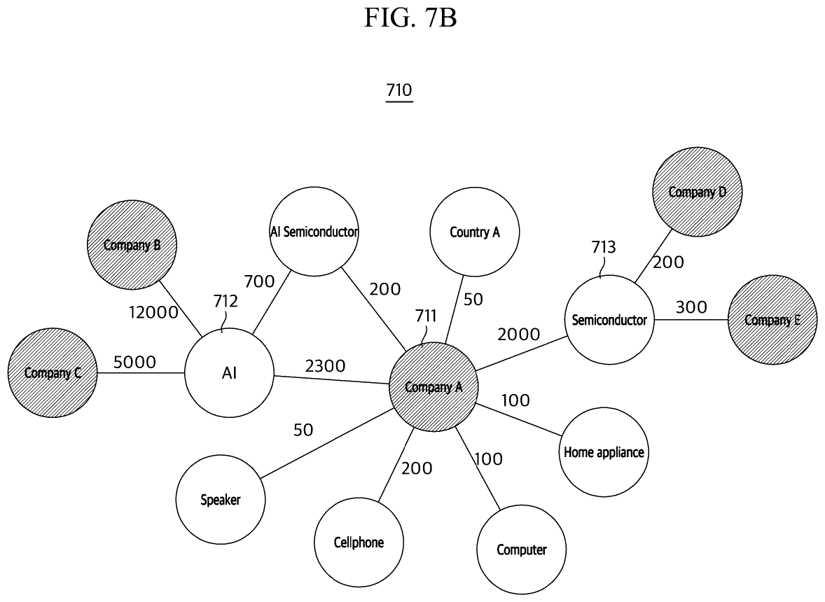

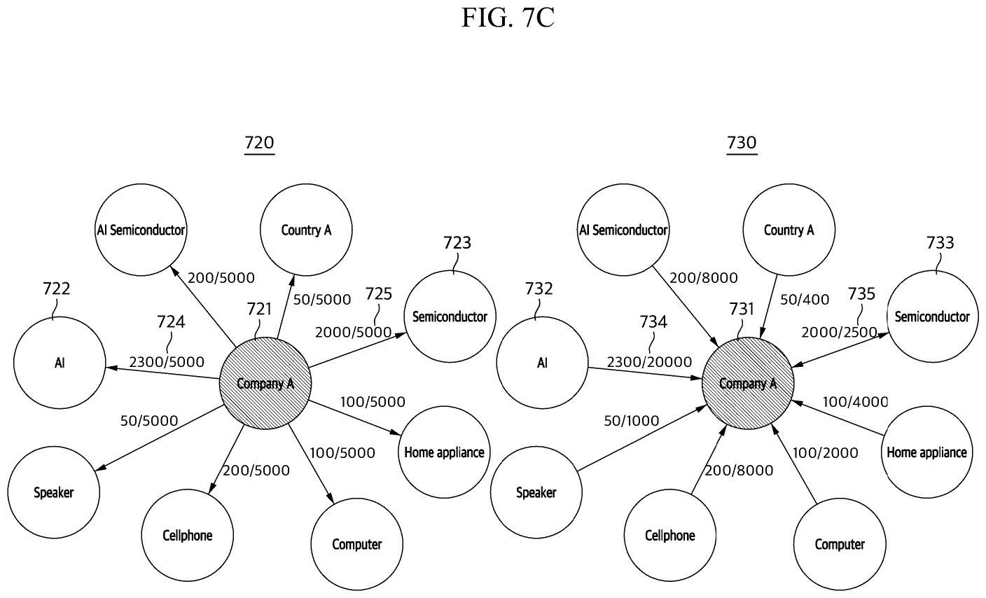

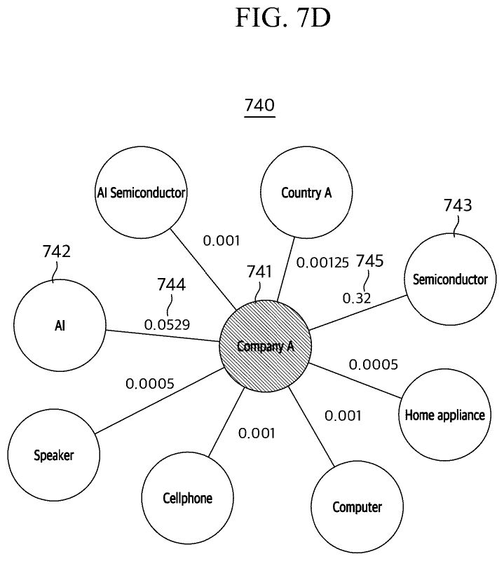

FIG. 7A is a diagram for explaining a weighted co-occurrence graph generated based on a keyword set, the total number of times that keywords appear, and a first weight according to an example embodiment.

Weights may be given to the text data itself based on the time when the text data was generated. For example, among text data included in the text set, a greater weight may be given to text data of which generation time is more recent and text data that is generated later may be given a smaller weight. Although the industry of a specific company changes after a certain point in time, the specific company may be classified into a set related to the industry after change, rather than the industry before change, as a greater weight may be given to the latest text data. In the present disclosure, the weight given to text data depending on the generation time may be defined as the first weight, and a co-occurrence graph identified further based on the first weight may be referred to as a weighted co-occurrence graph. Referring to FIG. 7A, a weighted co-occurrence graph 700 may be a co-occurrence graph in which the first text data 310 and the second text data 320 are given different first weights based on information about times when the first text data 310 and the second text data 320 are generated.

According to an example embodiment, the electronic device 100 may determine the first weight of each text data based on information about the generation time of each text data in the text set. Further, based on the total number of times that keywords appear and the first weight, the electronic device 100 may identify the modified total number of times for each of the keyword pairs consisting of any two keywords included in the keyword set. Here, the modified total number of times may be determined through a predetermined calculation using the total number of times that keywords appear and the first weight. For example, the predetermined calculation may be multiplying the total number of times that keywords appear by the first weight.

In an example embodiment, 2 may be set as the first weight for the first text data 310 in the text set illustrated in FIG. 3, and 1 may be set as the first weight in the second text data 320. Here, the electronic device 100 may identify the modified weight of an edge 703 between a node 702 corresponding to “Semiconductor” and a node 701 corresponding to “Company B” as the modified total number of times based on the weighted co-occurrence graph 700. The modified weight of the edge 703 between the node 702 corresponding to “Semiconductor” and the node 701 corresponding to “Company B” may be calculated as 5, which is the sum of 1) 4 which is the product of 2, the weight of the edge 503 in the co-occurrence graph 500, and 2, the first weight of the first text data 310 and 2) 1 which is the product of 1, the weight of the edge 513 in the co-occurrence graph 510, and 1, the first weight of the second text data 320. Accordingly, the weighted co-occurrence graph 700 may be illustrated as shown in FIG. 7A.

FIG. 7B is a diagram for explaining a co-occurrence graph generated based on a keyword set and the total number of times that keywords appear according to another example embodiment.

FIG. 7C illustrates diagrams for explaining a directed weighted co-occurrence graph generated based on a keyword set and the total number of times that keywords appear.

Referring to FIG. 7B, the electronic device 100 may identify the total number of times that a keyword pair is included together in each of at least one text element based on the text set, and the co-occurrence graph may be determined based on the keyword set and the total number of times. A co-occurrence graph 710 may include a first node 711 corresponding to “Company A,” a second node 712 corresponding to “AI,” and a third node 713 corresponding to “Semiconductor,” at least one node connected to each of the first node 711, the second node 712, and the third node 713, and weights of the edges corresponding to the connections. In FIG. 7B, the node corresponding to “Company A” may be referred to as the first node 711, the node corresponding to “AI” may be referred to as the second node 712, and the node corresponding to “Semiconductor” may be referred to as the third node 713.

Referring to the co-occurrence graph 710, the first node 711 corresponding to “Company A” may be connected to a node corresponding to “AI Semiconductor,” the node corresponding to “AI,” a node corresponding to “Speaker,” a node corresponding to “Cellphone,” a node corresponding to “Computer,” a node corresponding to “Home appliance,” the node corresponding to “Semiconductor,” and a node corresponding to “Country A.” The weight of an edge may correspond to the total number of times in which a keyword pair corresponding to two nodes connected to the edge appears together in each of at least one text element. For example, the weight of the edge between the first node 711 and the second node 712 may be 2300, which is the total number of times that “Company A” and “AI” appear together in each of the at least one text element. Further, the weight of the edge between the first node 711 and the third node 713 may be 2000, which is the total number of times that “Company A” and “Semiconductor” appear together in each of the at least one text element.

According to an example embodiment, the electronic device 100 may identify the total number of times (in other words, the total number of times of a specific keyword) that the specific keyword is included in at least one text element together with another keyword that forms a keyword pair. The electronic device 100 may determine the degrees of association of the keyword pairs including the specific keyword further based on the total number of times of the specific keyword. For example, based on a ratio of the total number of times of each of the keyword pairs based on the total number of times of the specific keyword, the electronic device may determine the degree of association of each of the keyword pairs.

For example, based on the co-occurrence graph 710, the electronic device 100 may identify the total number of times (in other words, the total number of times of “Company A”) that “Company A” corresponding to the first node 711 is included in at least one text element together with other keywords (for example, “AI Semiconductor,” “AI,” “Semiconductor,” “Country A” and so on) that form a keyword pair. Further based on the total number of times of “Company A” (for example, based on a ratio of the number of times of each keyword pair based on the total number of times of “Company A”), the electronic device 100 may also determine the degree of association of each keyword pair including “Company A.”

When determining the degree of association of a keyword pair, if the total number of times of a specific keyword is more considered, the electronic device 100 may determine the degree of association of a keyword pair to decrease the influence of whether the specific keyword is prevalent and for the degree of association to further correspond to the actual correlation between keywords. For example, if an increased interest level for a specific keyword leads to a rapid increase in financial news stories related to the specific keyword, a ratio of the specific keyword in the financial news of each company may rapidly increase. In other words, depending on whether a specific keyword is prevalent, the degree of association between each company and the specific keyword may be determined higher than an actual correlation. In this case, the electronic device 100 may determine the degree of association between each company and the specific keyword based on the total number of times of the specific keyword in order to decrease the influence of whether the specific keyword is prevalent. Conversely, when determining the degree of association not further considering the total number of times of a specific keyword (in other words, when determining the degree of association according to the manners explained in FIGS. 5 and 6), the electronic device 100 may determine the degree of association between keywords relatively further based on whether the specific keyword is recently prevalent, in other words, recent social interest levels.

For example, Company A may be a manufacturing company that manufactures various electronic products such as AI semiconductors, mobile phones, computers, and home appliances, centering on semiconductors. In other words, “Semiconductor” may be a keyword of high association with Company A. Conversely, as “AI” is not irrelevant to Company A but is slightly distant from a major business field in which Company A currently engages, “AI” may be a keyword of relatively low association with Company A. Specifically, “AI” may be a keyword whose association with Company B or Company C, which are software companies, is relatively higher than the association with Company A. However, as social interest in “AI” rapidly increases, text data including “AI” may rapidly increase. Accordingly, “Company A” may appear in text data together with “AI,” the keyword of relatively low association compared to “Semiconductor,” in higher frequency. For example, referring to FIG. 7B, the total number of times that “Company A” and “Semiconductor” are included together in each of the at least one text element may be 2000, while the total number of times that “Company A” and “AI” are included together in each of the at least one text element may be 2300. With regard thereto, in order to identify the relative degree of association focused on a specific keyword compared to another keyword, the electronic device 100 may determine a directed weighted co-occurrence graph.

Referring to FIG. 7C, a directed weighted co-occurrence graph 720 may include a first node 721 corresponding to “Company A,” and a directed weighted co-occurrence graph 730 may include a first node 731 corresponding to “Company A.” The directed weighted co-occurrence graph 720 of FIG. 7C may include at least one first sub weight that is from the first node 721 to at least one node. In addition, the directed weighted co-occurrence graph 730 may include at least one second sub weight that is from at least one node to the first node 731. The nodes connected to the first node 721 in the directed weighted co-occurrence graph 720 may be referred to as a connection node in relationship with the first node 721. Similarly, the nodes connected to the first node 731 in the directed weighted co-occurrence graph 730 may be referred to as a connection node in relationship with the first node 731.

According to an example embodiment, the first sub weight between the first node 721 and a connection node for the first node 721 may be identified based on a first total number of times that a keyword corresponding to the first node 721 and a keyword corresponding to the connection node are included together in each of at least one text element and a second total number of times that the keyword corresponding to the first node 721 is included in each of at least one text element. In addition, the second sub weight between the first node 731 and a connection node for the first node 731 may be identified based on the first total number of times and a third total number of times that the keyword corresponding to the connection node is included in each of at least one text element. Specifically, e′_{i→j}; which is the sub weight from an ith node (the i-th node) to a jth node (the j-th node) in a directed weighted co-occurrence graph may be calculated by Equation 1.

$${e}_{i \to j}^{′} = \frac{{e}_{ij}}{deg ( i )} = \frac{{e}_{ij}}{{\sum }_{r = 1}^{k} {e}_{ir}} \qquad [ Equation 1 ]$$

eᵢⱼ may be the total number of times that a keyword corresponding to the i-th node (hereinafter referred to as the i-th keyword) and a keyword corresponding to the j-th node (hereinafter referred to as the j-th keyword) are included together in each of at least one text element. deg(i) may be the total number of times that the i-th keyword is included in each of the at least one text element. In a directed weighted co-occurrence graph, there may be k number of nodes connected to the i-th node. In other words, for the i-th node and k number of connection nodes, deg(i) may be the total number of times that one of k number of keywords corresponding to the k number of connection nodes and the i-th keyword are included together in each of the at least one text element. In other words, e′_{i→j} indicates the relative degree of association that the i-th keyword is focused on the j-th keyword among the k number of keywords and may be a value between 0 and 1.

In the directed weighted co-occurrence graph 720, nodes corresponding to “Company A,” “AI,” and “Semiconductor” may be the first node 721, a second node 722, and a third node 723, respectively. With regard to the directed weighted co-occurrence graph 720, deg (i) which is the total number of times that “Company A” is included in each of the at least one text element may be identified as 5000 which is the sum of the weights of the edges between one of the connection nodes and the first node 721. Since the total number of times that “Company A” and “AI” are included together in each of the at least one text element is 2300, a first sub weight 724 from the first node 721 corresponding to “Company A” to the second node 722 corresponding to “AI” may be identified as 2300/5000. Similarly, since the total number of times that “Company A” and “Semiconductor” are included together in each of the at least one text element is 2000, a first sub weight 725 from the first node 721 corresponding to “Company A” to the third node 723 corresponding to “Semiconductor” may be identified as 2000/5000. As a similar process is performed, the directed weighted co-occurrence graph 720 of FIG. 7C may be determined.

Before the directed weighted co-occurrence graph 730 is determined, the total number of times by keyword for each connection node connected to the first node 731 corresponding to “Company A” may be determined first. Referring to FIG. 7B, the total number of times related to “AI” among the connection nodes is the total number of times that “AI” is included in each of the at least one text element together with one of “Company A,” “Company B,” “AI Semiconductor,” and “Company C” and may be 20000. Similarly, referring to FIG. 7B, the total number of times related to “Semiconductor” among the connection nodes is the total number of times that “Semiconductor” is included in each of the at least one text element together with one of “Company A,” “Company D,” and “Company E” and may be 2500.

Since the total number of times that “Company A” and “AI” are included together in each of the at least one text element is 2300, a second sub weight 734 from a second node 732 corresponding to “AI” to the first node 731 corresponding to “Company A” may be identified as 2300/20000. Since the total number of times that “Company A” and “Semiconductor” are included together in each of the at least one text element is 2000, a second sub weight 735 from a third node 733 corresponding to “Semiconductor” to the first node 731 corresponding to “Company A” may be identified as 2000/2500. As a similar process is performed, the directed weighted co-occurrence graph 730 of FIG. 7C may be determined.

FIG. 7D is a diagram for explaining a directed weighted co-occurrence graph in which a degree of association of a keyword pair is indicated.

According to an example embodiment, by performing a predetermined calculation using at least one first sub weight and at least one second sub weight, the electronic device 100 may identify degrees of association of keyword pairs each having a combination of any one of keywords related to a specific keyword and the specific keyword. In an example embodiment related to the predetermined calculation, degree of association Eᵢⱼ of a keyword pair consisting of an i-th keyword and a j-th keyword according to the predetermined calculation may be calculated by Equation 2.

$${E}_{ij} = {e}_{i \to j}^{′} \times {e}_{j \to i}^{′} = \frac{{e}_{ij}}{deg ( i )} \times \frac{{e}_{ij}}{deg ( j )} = \frac{{e}_{ij}}{{\sum }_{r = 1}^{p} {e}_{ir}} \times \frac{{e}_{ij}}{{\sum }_{r = 1}^{q} {e}_{rj}} \qquad [ Equation 2 ]$$

Eᵢⱼ is a numerical value of the association of a keyword pair consisting of the i-th keyword and the j-th keyword and may be a result value of multiplication based on e′_{i→j} and e′_{j→i}. In various example embodiments, the association of the keyword pair consisting of the i-th keyword and the j-th keyword may be the result value of a sum or another weighted operation, in addition to the multiplication based on e′_{i→j} and e′_{j→i}. deg (i) may be the total number of times related to the i-th keyword. In the directed weighted co-occurrence graph, there may be p number of connection nodes that are connected to the node corresponding to the i-th keyword, and the number of keywords that are included in at least one element at least one time together with the i-th keyword may be p. In other words, deg (i) may be the total number of times that one of p number of keywords and the i-th keyword are included together in each of the at least one text element. e′_{i→j} indicates a relative degree of association that the i-th keyword is focused on the j-th keyword compared to p number of keywords and may be a value between 0 and 1. Further, deg(j) may be the total number of times related to the j-th keyword. In the directed weighted co-occurrence graph, there may be q number of connection nodes connected to the node corresponding to the j-th keyword, and the number of keywords that are included in at least one element at least one time together with the j-th keyword may be q. In other words, deg(j) may be the total number of times that one of q number of keywords and the j-th keyword are included together in each of the at least one text element. In other words, e′_{j→i} is a relative degree of association that the j-th keyword is focused on the i-th keyword compared to q number of keywords and may be a value between 0 and 1. In other words, degree of association Eᵢⱼ of the i-th keyword and the j-th keyword may be a value that is calculated comprehensively based on a relative degree of association focused on the j-th keyword of the i-th keyword and a relative degree of association focused on the i-th keyword of the j-th keyword.

According to an example embodiment, the electronic device 100 may determine a degree of association of a keyword pair through a predetermined calculation using the first sub weight of the directed weighted co-occurrence graph 720 shown in FIG. 7C and the second sub weight of the directed weighted co-occurrence graph 730. The weight of an edge of a directed weighted co-occurrence graph 740 may be a degree of association of a keyword pair corresponding to two nodes connected to the edge. Here, the keyword pair may consist of “Company A” and one of the keywords corresponding to nodes connected to the node corresponding to “Company A.”

The degree of association between “Company A” and “AI” is

$$\frac{2300}{5000} \times \frac{2300}{20000}$$

and may be 0.0529. More specifically, a weight 744 of the edge between a node 741 corresponding to “Company A” and a node 742 corresponding to “AI” may be 0.0529. The degree of association between “Company A” and “Speaker” is

$$\frac{50}{5000} \times \frac{50}{1000}$$

and may be 0.0005. The degree of association between “Company A” and “Cellphone” is

$$\frac{200}{5000} \times \frac{200}{8000}$$

and may be 0.001. The degree of association between “Company A” and “Computer” is

$$\frac{100}{5000} \times \frac{100}{2000}$$

and may be 0.0001. The degree of association between “Company A” and “Home appliance” is

$$\frac{100}{5000} \times \frac{100}{4000}$$

and may be 0.0005. The degree of association between “Company A” and “Semiconductor” is

$$\frac{2000}{5000} \times \frac{2000}{2500}$$

and may be 0.32. More specifically, a weight 745 of the edge between the node 741 corresponding to “Company A” and a node 743 corresponding to “Semiconductor” may be 0.32. The degree of association between “Company A” and “Country A” is

$$\frac{50}{5000} \times \frac{50}{400}$$

and may be 0.00123.

In other words, referring to FIG. 7B, the total number of times that “Company A” and “Semiconductor” are included together in each of the at least one text element is 2000, which is less than 2300, the total number of times that “Company A” and “AI” are included together in each of the at least one text element. However, referring to FIG. 7D, when the degree of association is calculated based on the total number of times of each keyword, the degree of association between “Company A” and “Semiconductor” may be calculated to be greater than the degree of association between “Company A” and “AI.” As the degree of association of a keyword pair is determined based on a directed weighted co-occurrence graph, the electronic device 100 may decrease the influence of whether a specific keyword is prevalent and determine a degree of association between keywords of which actual correlation is high to be higher.

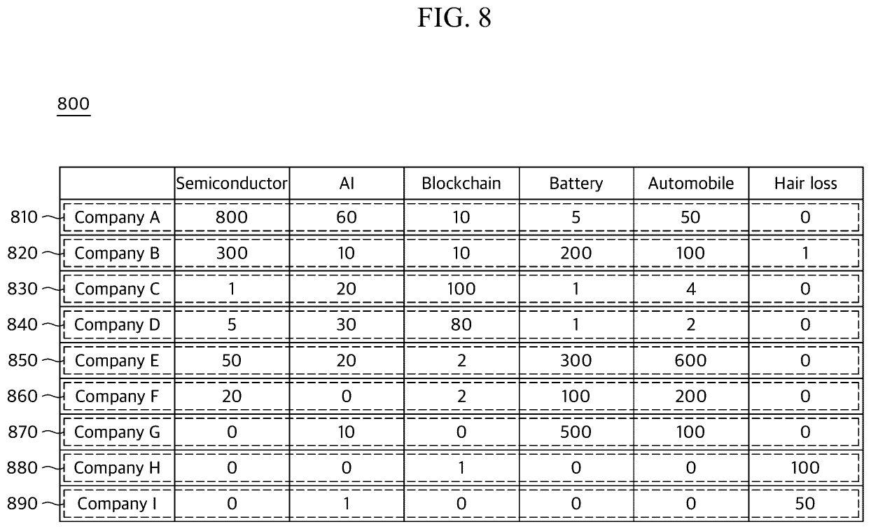

FIG. 8 is a diagram for explaining a co-occurrence matrix corresponding to a co-occurrence graph, a weighted co-occurrence graph, or a directed weighted co-occurrence graph.

The co-occurrence graph, the weighted co-occurrence graph, or the directed weighted co-occurrence graph explained above in FIGS. 5, 6, and 7A to 7D may be represented as a keyword matrix of size n*n for n number of keywords included in the keyword set. For example, the total number of times that an i-th keyword and a j-th keyword among the n number of keywords appear together in at least one text element may be represented as a weight of an edge between an i-th node and a j-th node in a co-occurrence graph, a weighted co-occurrence graph, or a directed weighted co-occurrence graph and may be represented as an element value of (i, j) or (j, i) in a keyword matrix.

According to an example embodiment, the keyword matrix of size n*n may be reconstructed as a co-occurrence matrix based on a number of target keywords included in the n number of keywords. A co-occurrence matrix is a matrix corresponding to a co-occurrence graph, a weighted co-occurrence graph, or a directed weighted co-occurrence graph and may be a matrix that includes each of at least one vector corresponding to each of at least one target keyword as a row or a column. In this case, the co-occurrence matrix may be identified by indexing a keyword matrix based on the at least target keyword. When the number of target keywords included in the keyword set is a, the size of a co-occurrence matrix may be identified as a*n or n*a depending on whether the indexing direction is the direction of rows or the direction of columns. However, the size of the co-occurrence matrix is not limited to a*n or n*a. For example, when the size of a co-occurrence matrix is a*n, a number of columns corresponding to at least one target keyword among n number of columns in the co-occurrence matrix may be filtered. In this case, the size of the co-occurrence matrix may be determined as a*(n−a). For convenience of explanation, FIG. 8 illustrates a co-occurrence matrix 800 composed of 9 target keywords and 6 keywords in the form of a*(n−a). The rows of the co-occurrence matrix 800 correspond to 9 target keywords including “Company A,” “Company B,” “Company C,” “Company D,” “Company E,” “Company F,” “Company G,” “Company H,” and “Company I,” and the columns of the co-occurrence matrix 800 correspond to 6 keywords for “Semiconductor,” “AI,” “Blockchain,” “Battery,” “Automobile,” and “Hair loss,” as columns corresponding to the 9 target keywords are filtered.

The co-occurrence matrix 800 may include a first row 810, a second row 820, a third row 830, a fourth row 840, a fifth row 850, a sixth row 860, a seventh row 870, an eighth row 880, and a ninth row 890 corresponding to “Company A,” “Company B,” “Company C,” “Company D,” “Company E,” “Company F,” “Company G,” “Company H,” and “Company I,” respectively. The first row 810 may indicate each element of a first vector corresponding to “Company A.” Similarly, the second row 820, the third row 830, the fourth row 840, the fifth row 850, the sixth row 860, the seventh row 870, the eighth row 880, and the ninth row 890 may indicate each element of a second vector, a third vector, a fourth vector, a fifth vector, a sixth vector, a seventh vector, an eighth vector, and a ninth vector that correspond to “Company B,” “Company C,” “Company D,” “Company E,” “Company F,” “Company G,” “Company H,” and “Company I,” respectively.

Each element of a first vector corresponding to a first target keyword among at least target keyword according to an example embodiment may correspond to each keyword. Each element of the first vector may be identified based on the total number of times that each corresponding keyword and the first target keyword are included together in at least one text element. The example embodiment of FIG. 8 is based on the total number of times that each keyword corresponding to each element of the first vector and the first target keyword are included together in the at least one text element, but the co-occurrence matrix of the present disclosure is not limited thereto.

For example, referring to the first row 810, a first element of the first vector may be identified as 800, which is the total number of times that “Company A” and “Semiconductor” are included together in each of the at least one text element. In addition, a second element of the first vector may be identified as 60, which is the total number of times that “Company A” and “AI” are included together in each of the at least one text element. The first vector corresponding to “Company A” according to FIG. 8 may be identified as [800, 60, 10, 5, 50, 0]. Similarly, elements of each vector corresponding to “Company B,” “Company C,” “Company D,” “Company E,” “Company F,” “Company G,” “Company H,” and “Company I” may be identified as shown in FIG. 8.

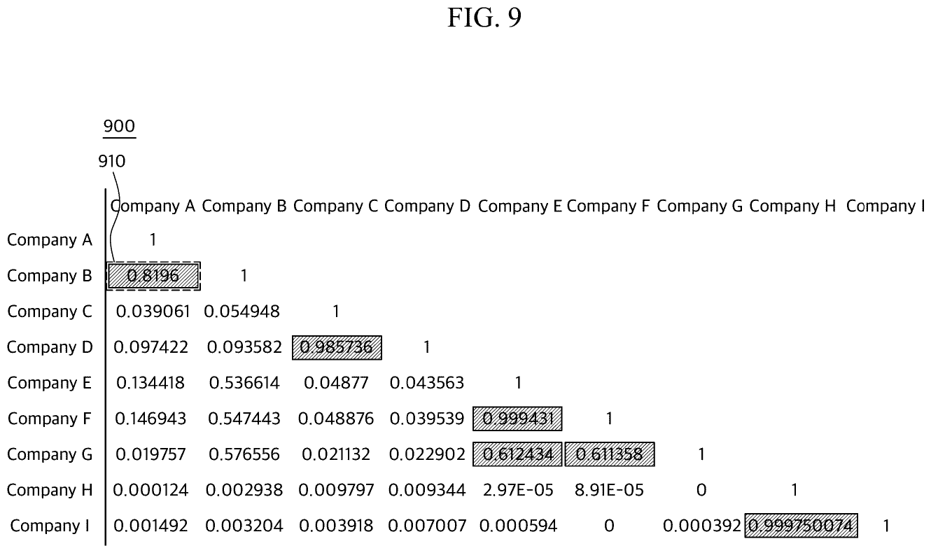

FIG. 9 is a diagram for explaining a method of identifying a similarity between at least one target keyword based on at least one vector.

Referring to FIG. 9, a similarity matrix 900 according to an example embodiment is illustrated. A similarity matrix may be a matrix having each of the similarity between at least one target keyword as an element. A value corresponding to an ith row and a jth column in a similarity matrix shows a similarity between an ith target keyword and a jth target keyword. Since a similarity matrix may be a symmetric matrix, the similarity matrix may be briefly represented as a lower triangular matrix. Referring to FIG. 9, the similarity matrix 900 shows similarities between “Company A,” “Company B,” “Company C,” “Company D,” “Company E,” “Company F,” “Company G,” “Company H,” and “Company I.”

According to an example embodiment, based on a cosine similarity between the at least one vector corresponding to the at least one target keyword, the electronic device 100 may identify the similarity between the at least one target keyword. A great value of a cosine similarity may indicate that the directions of vectors are similar, and the value of a cosine similarity may have a value between 0 and 1.

For example, referring to FIG. 8, a cosine similarity between [800, 60, 10, 5, 50, 0], the first vector corresponding to “Company A,” and [300, 10, 10, 200, 100, 1], the second vector corresponding to “Company B,” may correspond to a value of a first element 910 of the second row and the first column in the similarity matrix 900. Referring to FIG. 9, the cosine similarity between the first vector and the second vector may be calculated as 0.8196. Other values in the similarity matrix 900 may also be calculated according to a similar manner.

A target keyword pair of which a similarity included in the similarity matrix 900 is greater than or equal to 0.6, a set value, may be classified as target keywords with a high similarity. Referring to FIG. 9, the similarity that is greater than or equal to 0.6, the set value, among the similarity included in the similarity matrix 900 is indicated as shaded. For example, each of [Company A, Company B], [Company C, Company D], [Company E, Company F, and Company G], and [Company H, Company I] may be classified as target keywords with a high similarity to each other.

FIG. 10 shows a dendrogram according to hierarchical clustering using a similarity between at least one target keyword.

According to an example embodiment, based on hierarchical clustering using the similarity between at least one target keyword, the electronic device 100 may identify at least one set including at least some of the at least one target keyword. More specifically, the electronic device 100 may cluster at least one target keyword into at least one set based on a dendrogram generated according to hierarchical clustering using a similarity between at least one target keyword and a set value. Here, the set value may indicate a criterion for classifying target keywords into an identical set. Referring to FIG. 10, the set value may be 0.6, but it is not limited thereto.

In the present disclosure, hierarchical clustering may be an algorithm that performs clustering by hierarchically incorporating individual entities (in the present disclosure, the individual entities may correspond to target keywords.) into a set using a hierarchical tree model. The hierarchical clustering may be either agglomerative hierarchical clustering or divisive hierarchical clustering. In addition, a manner of calculating a similarity among a cluster may be one of a single link method, a complete link method, a group average method, a method through a distance between centroids, and a ward linkage method. The single link method may be a manner of calculating a similarity among a cluster based on the similarity of the most similar entities within the cluster. In addition, the complete link method may be a manner of calculating a similarity among a cluster based on the similarity of the most dissimilar entities within the cluster. The group average method may be a manner of calculating a similarity among a cluster based on the average similarity among entities within the cluster. The method through the distance between centroids may be a manner of calculating a similarity among a cluster based on the similarity between centroids by cluster. The ward linkage method may be a manner of calculating a similarity among a cluster based on the sum of squares of deviations within the cluster. In the example embodiments below, the similarity among a cluster may be calculated based on the method through the distance between centroids, but it is not limited thereto.

Referring to FIG. 10, a dendrogram 1000 may be generated through hierarchical clustering based on the similarity between at least one target keyword of FIG. 9. For example, each of [Company A, Company B], [Company C, Company D], [Company E, Company F, and Company G], and [Company H, Company I] of FIG. 9 may be classified as target keywords with a high similarity to each other and thus may be clustered into an identical set.

According to an example embodiment, a first representative keyword corresponding to a first set that is classified as target keywords with a high similarity to each other and clustered may be determined based on at least one first vector corresponding to at least one first target keyword included in the first set. For example, when a value of an ith element of each of the at least one first vector is greater than or equal to a set value, a keyword corresponding to the ith element may be identified as a representative keyword of the first set. For example, if the set value is 1, the first representative keyword may indicate a keyword connected to all of the at least one first target keyword on a co-occurrence graph, a weighted co-occurrence graph, or a directed weighted co-occurrence graph. In other words, the first representative keyword may be a keyword that appears at least once in at least one text element together with each of the at least one first target keyword.

According to an example embodiment, when the first representative keyword is plural, a sort order of a plurality of representative keywords may be determined based on degrees of association between each of the plurality of the first representative keyword and each of the at least one first target keyword. For example, when the sum of degrees of association between one representative keyword among the plurality of the first representative keyword and each of the at least one first target keyword is large, the corresponding representative keyword may be determined relatively ahead in the sort order. Conversely, when the sum of degrees of association between one representative keyword among the plurality of the first representative keyword and each of the at least one first target keyword is small, the corresponding representative keyword may be determined relatively behind in the sort order.

According to an example embodiment, the electronic device 100 may identify a part alone of keywords that appear at least once in the at least one text element together with the at least one first target keyword as representative keywords by a set rule. More specifically, among keywords connected to the at least one target keyword on a co-occurrence graph or a weighted co-occurrence graph, the electronic device 100 may identify a keyword of the top N number or the top M % from the largest of the total number of times of appearing in the at least one text element together with at least one of the at least one first target keyword as the first representative keyword. For example, an example embodiment where N=2 may be explained hereinafter in the present disclosure. In this case, among the keywords connected to the at least one target keyword on the co-occurrence graph, the first representative keyword may include keywords of the top two from the largest of the total number of times of appearing in the at least one text element together with at least one of the at least one first target keyword as the first representative keyword as the first representative keyword, but it is not limited thereto.

According to an example embodiment, the similarity between “Company A” and “Company B” is “0.8196” and may be greater than 0.6, the set value. Therefore, “Company A” and “Company B” may be clustered into a first set. Further, referring to FIG. 8, the first representative keyword of the first set may be determined as at least one of “Semiconductor,” “AI,” “Blockchain,” “Battery,” and “Automobile.”

More specifically, keywords connected to both a node corresponding to “Company A” and a node corresponding to “Company B” on a co-occurrence graph or a weighted co-occurrence graph may be “Semiconductor,” “AI,” “Blockchain,” “Battery,” and “Automobile.” In addition, referring to the first row 810 and the second row 820, a weight related to “Semiconductor” may be “1100.” Specifically, “1100” may be the sum of “800” which is a value of the first element corresponding to “Semiconductor” among elements of the first vector and “300” which is a value of a first element corresponding to “Semiconductor” among elements of the second vector. Similarly, referring to the first row 810 and the second row 820, each of weights related to “AI,” “Blockchain,” “Battery,” and “Automobile” other than “Semiconductor” may be identified as 70, 20, 205, and 150. According to an example embodiment, keywords of the top two from the largest of the total number of times that target keywords included in the first set appear together may be determined as the first representative keywords. In this case, “Semiconductor” and “Battery” may be determined as the first representative keywords of the first set, and the first representative keywords of the first set may be sorted in the order of “Semiconductor” and “Battery.”

The similarity between “Company C” and “Company D” is 0.985736 and may be greater than 0.6, the set value. Therefore, “Company C” and “Company D” may be clustered into a second set. According to a manner similar to the manner of determining the first representative keyword of the first set above, second representative keywords of the second set may be determined as “Blockchain” and “AI.”

The similarity between “Company E” and “Company F” is 0.99943 and may be greater than 0.6, the set value. Therefore, “Company E” and “Company F” may be classified as target keywords with a high similarity and may be clustered. In relationship with “Company G,” “Company E” and “Company F” may be understood as a subset. In this case, a similarity between “Company G,” “Company E,” and “Company F” may be determined as a similarity between “Company G” and the subset [Company E, Company F]. The similarity between “Company G” and the subset [Company E, Company F] may be determined as a similarity between a vector corresponding to “Company G” and a vector corresponding to the subset [Company E, Company F], for example, a centroid vector of the subset [Company E, Company F].

A centroid vector of a set may be a vector representing target keywords included in the set (or a subset) and may be identified based on a predetermined calculation process based on vectors corresponding to the target keywords included in the set. Here, the predetermined calculation process may include a normalization process. The centroid vector of the subset including [Company E, Company F] may be calculated as an average of a fifth normalized vector of size 1 according to normalizing the fifth vector and a sixth normalized vector of size 1 according to normalizing the sixth vector. The fifth normalized vector may be [0.074296, 0.029719, 0.002972, 0.445778, 0.891555, 0], and the sixth normalized vector may be [0.089084, 0, 0.008908, 0.445418, 0.890835, 0]. In other words, the centroid vector of the subset including [Company E, Company F] may be [0.08169, 0.014859, 0.00594, 0.445598, 0.891195, 0]. Accordingly, the similarity between the seventh vector corresponding to “Company G” and the centroid vector of the subset including [Company E, Company F] is 0.61198 and may be greater than 0.6, the set value. Therefore, “Company E,” “Company F,” and “Company G” may be clustered into a third set, and the third set may include the subset including “Company E” and “Company F.”

According to a manner similar to the manner of determining the first representative keyword of the first set above, a third representative keyword of the third set may be determined as “Battery” and “Automobile.” In other words, “Battery” and “Automobile” which are the largest two keywords of the sum of corresponding weights among representative keywords of the third set may be determined as the third representative keywords of the third set. Referring to FIG. 8, weights related to “Battery” and “Automobile” are “900,” which may be identical. Referring to the fifth row 850, the sixth row 860, and the seventh row 870, “900” which is the weight related to “Battery” may be the sum of “300” which is a value of a fourth element corresponding to “Battery” among elements of the fifth vector, “100” which is a value of a fourth element corresponding to “Battery” among elements of the sixth vector, and “500” which is a value of a fourth element corresponding to “Battery” among elements of the seventh vector. Further, referring to the fifth row 850, the sixth row 860, and the seventh row 870, “900” which is the weight related to “Automobile” may be the sum of “600” which is a value of a fifth element corresponding to “Automobile” among elements of the fifth vector, “200” which is a value of a fifth element corresponding to “Automobile” among elements of the sixth vector, and “100” which is a value of a fifth element corresponding to “Automobile” among elements of the seventh vector. When weights related to representative keywords are identical, the representative keywords may be sorted in order from the smallest of standard deviations based on values of elements. For example, since a standard deviation based on [600, 200, 100] is greater than that based on [300, 100, 500], a sort order of the third representative keyword of the third set may be the order of “Battery” and “Automobile.” The similarity between “Company H” and “Company I” is 0.99975 and may be greater than 0.6, the set value. Therefore, “Company H” and “Company I” may be clustered into a fourth set. According to a manner similar to the manner of determining the first representative keyword of the first set above, a fourth representative keyword of the fourth set may be determined as “Hair loss.”

According to an example embodiment, at least one set of FIG. 10 may exclusively include at least one target keyword. However, some of the at least one target keyword may be included in a “plurality” of sets other than a “single” set (soft clustering). For example, referring to FIG. 8, it may be more appropriate that “Company B” which engages in various businesses such as “Semiconductor,” “Battery,” and “Automobile” is also included in another set in addition to the first set having “Semiconductor” as a representative keyword.

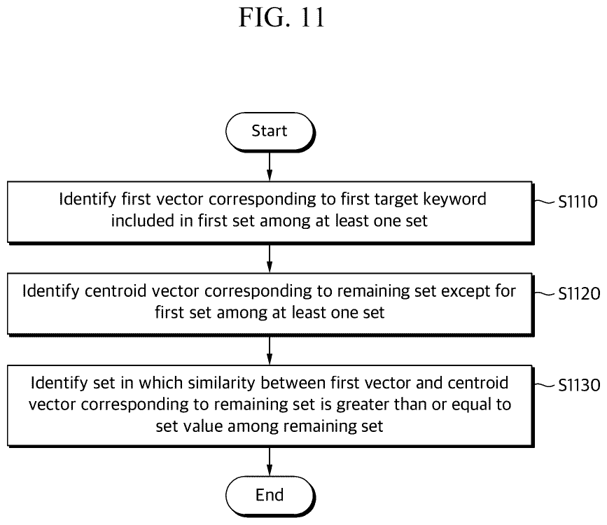

FIG. 11 is a flowchart for explaining a method of identifying a target keyword that is simultaneously included in a plurality of sets according to an example embodiment.

In operation S1110, the electronic device may identify a first vector corresponding to a first target keyword included in a first set among at least one set.

In operation S1120, the electronic device may identify a centroid vector corresponding to a remaining set except for the first set among at least one set.

According to an example embodiment, based on a vector corresponding to a target keyword included in each of the at least one set, the electronic device 100 may identify at least one centroid vector corresponding to each of the at least one set. A centroid vector of a set is a vector representing the set or target keywords included in the set and may be identified based on a predetermined calculation process based on vectors corresponding to the target keywords included in the set. Here, the predetermined calculation process may include a normalization process. As the size of a company is larger, economic news stories related to the company may be frequently published. Therefore, if a normalization process is not performed, a centroid vector of a set including a target keyword corresponding to a large company may be determined to be similar to a vector corresponding to the large company. In order for a single target keyword not to represent a set, by determining a centroid vector of the set based on one or more normalized vectors according to that one or more vectors are normalized by a set rule, the centroid vector of the set may be set to represent appropriately one or more target keywords included in the set.

Here, the set rule may be normalizing the size of a vector to L\hat{ }a when the size of the vector is L. In this case, index a may be a value between 0 and 1. For example, when index a is 0, the set rule may be converting one or more vectors into one or more normalized vectors of size 1. Further, when index a is ½, the set rule may be converting each of one or more vectors of size L into each of the normalized vectors of size L\hat{ }0.5. A centroid vector when index a is ½ may be more similar to the vector of the target keyword corresponding to the large company in terms of the direction of a vector than a centroid vector when index a is 0.

In operation S1130, the electronic device may identify a set in which a similarity between the first vector and the centroid vector corresponding to the remaining set is greater than or equal to a set value among the remaining set.

According to an example embodiment, the electronic device 100 may identify again or update the identified set in order that the first target keyword is further included in the identified set. Accordingly, the first target keyword may be included in the first set and may also be included in the identified set simultaneously.

For example, referring to FIGS. 8 and 10, “Company B” is a company that engages in various businesses such as “Semiconductor,” “Battery,” and “Automobile” and may be clustered into the first set along with “Company A.” “Company B” may frequently appear within finance-related unstructured data about “Semiconductor,” “Battery,” and “Automobile.” When index a is 0 and the size of a normalized vector is 1, the similarity between “Company B” and the remaining sets (for example, the second set to the fourth set) except for the first set may be calculated as described below.

A similarity between “Company B” and the second set may be calculated as 0.074531. More specifically, the second vector corresponding to “Company B” is identified as [300, 10, 10, 200, 100, 1], and a second centroid vector of the second set may be calculated as [0.034099, 0.273175, 0.957072, 0.1070739, 0.31275, 0]. Accordingly, a cosine similarity between the second centroid vector and the second vector may be calculated as 0.074531. When the set value, which is a criterion of the similarity between vectors for clustering, is 0.6, “Company B” may not be included in the second set.

A similarity between “Company B” and the third set may be calculated as 0.608547. More specifically, the second vector corresponding to “Company B” is identified as [300, 10, 10, 200, 100, 1], and a third centroid vector of the third set may be calculated as [0.05446, 0.016442, 0.00396, 0.623862, 0.65949, 0]. Accordingly, a cosine similarity between the third centroid vector and the second vector may be calculated as 0.608547. Since the cosine similarity between the third centroid vector and the second vector is greater than or equal to 0.6 which is the set value, “Company B” may be classified as a keyword with high similarities to target keywords included in the third set. Therefore, “Company B” may be included in the third set in addition to the first set. In other words, “Company B” may be a target keyword that is simultaneously included in a plurality of sets.

A similarity between “Company B” and the fourth set may be calculated as 0.003071. More specifically, the second vector corresponding to “Company B” is identified as [300, 10, 10, 200, 100, 1], and a fourth centroid vector of the fourth set may be calculated as [0, 0.009998, 0.005, 0, 0, 0.999875]. Accordingly, a cosine similarity between the fourth centroid vector and the second vector may be calculated as 0.003071. Since the calculated cosine similarity is less than 0.6 which is the set value, “Company B” may not be included in the fourth set.

Until at least one target keyword is not additionally incorporated into a new set other than the previous set that is identified in FIG. 10, the operation of identifying a target keyword that is simultaneously included in a plurality of sets of FIG. 11 may be performed repeatedly.

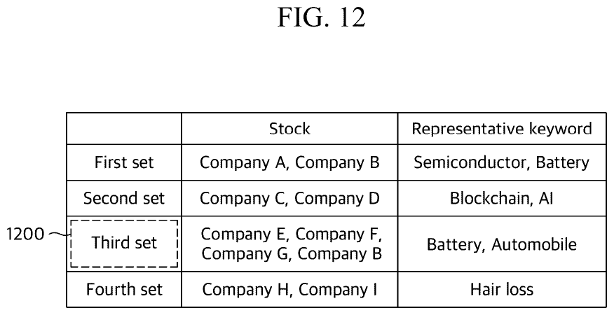

FIG. 12 is a diagram for explaining a result from clustering at least one target keyword into at least one set.

FIG. 12 shows a result according to that the operation of identifying a target keyword that is simultaneously included in a plurality of sets of FIG. 11 is performed repeatedly until at least one target keyword is not additionally incorporated into another set other than the previous set that is determined in FIG. 10. For example, no target keyword may be additionally incorporated into the first set, the second set, and the fourth set. Conversely, “Company B” may be additionally incorporated into a third set 1200 as described in FIG. 11.

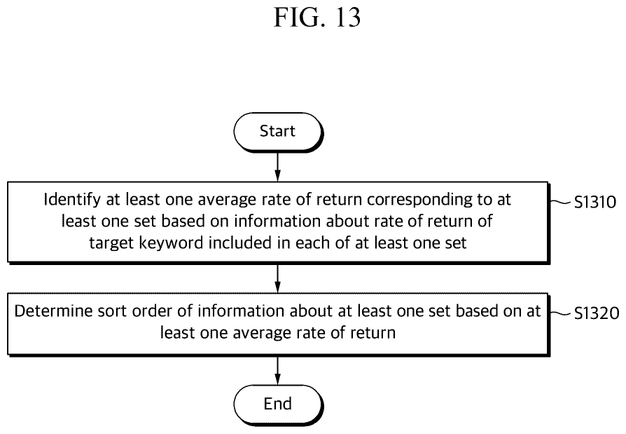

FIG. 13 is a flowchart showing a method of determining a sort order of information about at least one set according to an example embodiment.

In operation S1310, the electronic device may identify at least one average rate of return corresponding to at least one set based on information about a rate of return of a target keyword included in each of at least one set.

In operation S1320, the electronic device may determine a sort order of information about at least one set based on at least one average rate of return.

For example, referring to FIG. 12, an average rate of return corresponding to the first set may be determined based on a rate of return of “Company A” and a rate of return of “Company B.” Similarly, an average rate of return corresponding to the second set, an average rate of return corresponding to the third set, and an average rate of return corresponding to the fourth set may be determined based on rates of return of target keywords included in each of the second set, the third set, and the fourth set. The sort order of information about at least one set may correspond to an order from the greatest of the at least one average rate of return.

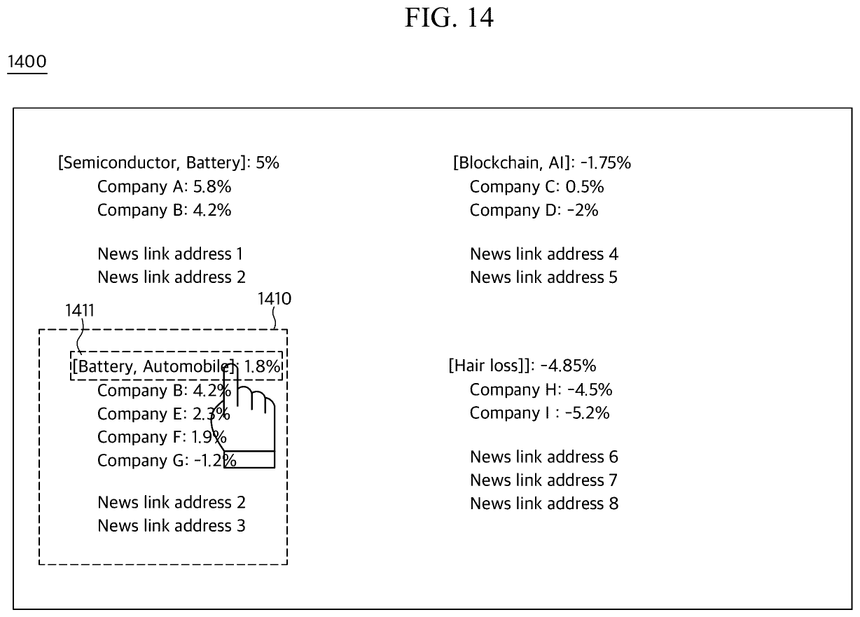

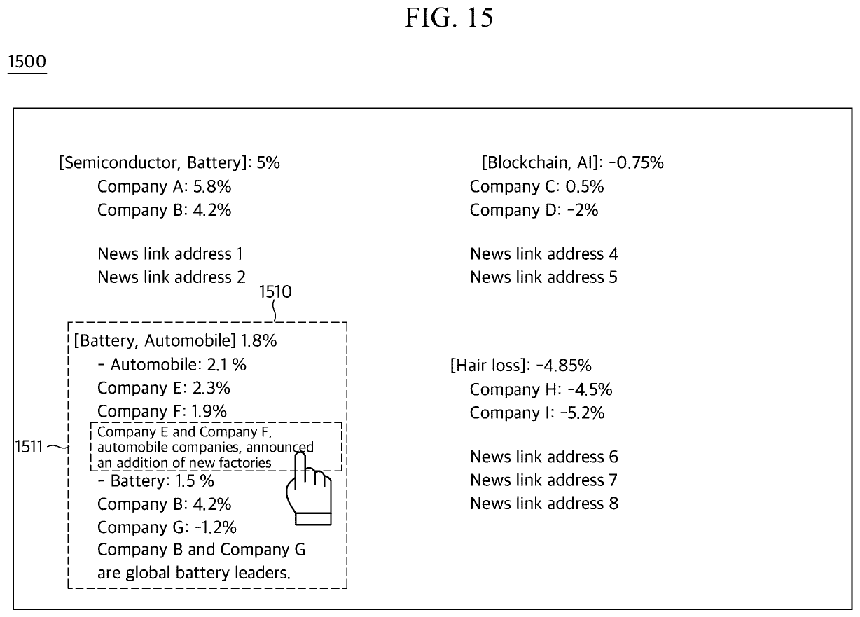

FIGS. 14 and 15 are diagrams according to an example embodiment in which information about at least one set is displayed on a terminal.

More specifically, FIGS. 14 and 15 show a screen of the terminal 110 in which information on a result from clustering at least one target keyword into at least one set according to the example embodiment of FIG. 12 is displayed.

Information about a first set among at least one set according to an example embodiment may include at least one of information about at least one first target keyword included in the first set, information on a rate of return of the at least one first target keyword included in the first set, and information about a representative keyword corresponding to the first set. In addition, the information about the first set among the at least one set may include at least one of link information of text data related to the at least one first target keyword and information on a text element related to the at least one first target keyword.

According to an example embodiment, average rates of return corresponding to the first set, the second set, the third set, and the fourth set may be 5%, −0.75%, 1.8%, and −4.85%, respectively. In other words, a sort order of information about at least one set may be an order of the first set, the third set, the second set, and the fourth set, which is an order from the greatest of an average rate of return. In a screen 1400, information on the first set, information on the third set, information on the second set, and information on the fourth set may be displayed in sequence.

An area 1410 of the terminal 110 may be an area in which information on the third set is displayed. In the area 1410, 1) “Battery” and “Automobile” which are representative keywords, 2) “Company B,” “Company E,” “Company F,” and “Company G” which are at least one target keyword included in the third set, 3) 4.2%, 2.3%, 1.9%, and −1.2% which are rates of return for each of the at least one target keyword included in the third set, 4) 1.8% which is an average rate of return corresponding to the third set, and 5) link information of text data related to the at least one target keyword may be displayed. Information about rates of return by target keyword may be displayed in different colors on the terminal 110 depending on whether a rate of return is a positive number or a negative number. For example, when a rate of return is a positive number, information about rates of return by target keyword may be displayed in red, and when a rate of return is a negative number, information about rates of return by target keyword may be displayed in blue. Information about the rates of return of “Company B,” “Company E,” and “Company F” may be displayed in red, and information about the rate of return of “Company G” may be displayed in blue.

The terminal 110 may receive a user input through an input interface and may transmit an output corresponding to the user input to the electronic device 100 through an output interface or display the output on a screen of the terminal 110. For example, when the user input is an input related to the third set among the at least one set, detailed information about the third set may be displayed on the screen of the terminal 110.

FIG. 15 shows a screen 1500 that is displayed in the terminal 110 in response to a user input through an area 1411 related to a representative keyword of the screen 1400 illustrated in FIG. 14.

For example, detailed information about the third set may be displayed on the screen 1500. An area 1510 of the terminal 110 related to the detailed information about the third set may include information about at least one subset included in the third set. Referring to FIG. 9, a cosine similarity between the fifth vector corresponding to “Company E” and the sixth vector corresponding to “Company F” is 0.999431, and “Company E” and “Company F” may be target keywords with very high similarity. A first subset within the third set may include “Company E” and “Company F,” and a representative keyword corresponding to the first subset may be identified as “Automobile.” In addition, according to the similarity matrix 900 of FIG. 9, “Company B” may have the highest similarity with “Company G” among “Company E,” “Company F,” and “Company G.” More specifically, “Company B” and “Company G” may be identified to appear in at least one text element more frequently with “Battery” among “Battery” and “Automobile” which are representative keywords of the third set. Accordingly, a second subset within the third set may include “Company B” and “Company G,” and a representative keyword corresponding to the second subset may be identified as “Battery.”

An average rate of return corresponding to the first subset and an average rate of return corresponding to the second subset may be 2.1% and 1.5%, respectively. A sort order of information about subsets displayed in the area 1510 of the terminal 110 may be determined as a descending order of an average rate of return corresponding to a subset. In other words, the order in which the information about subsets is displayed on the terminal 110 may be an order of the first subset and the second subset.

According to an example embodiment, in the area 1510 of the terminal 110, information about a text element related to a target keyword included in the first subset within the third set may be displayed. For example, a text element 1511 related to the first subset whose representative keyword is “Automobile” may be “Company E and Company F, automobile companies, announced an addition of new factories.”

In an area for the text element 1511, a link to finance-related news may be referenced. In other words, in response to a user input through the area for the text element 1511 related to the first subset, finance-related news data including the text element 1511 may be additionally displayed in the terminal 110. Accordingly, a user of the terminal 110 may easily identify a text element or text data related to at least one target keyword included in the first subset.

FIGS. 16 and 17 are flowcharts showing various preprocessing methods of text data related to filtering text elements corresponding to a set type.

Crawled text data may be preprocessed before determining the similarity of a keyword pair. With regard thereto, filtered may be a text element corresponding to a set type among at least one text element in a text set according to an example embodiment. For example, in a first text element including phrases related to market conditions, a plurality of stocks with a low degree of association with each other may be listed. In other words, when the first text element including phrases related to market conditions is filtered, the performance of clustering keywords with a high similarity may be greatly increased. Similarly, a second text element including advertising-related phrases may include false or exaggerated information regarding the purchase or sale of stock. In other words, when the second text element including the advertising-related phrases is filtered, the performance of clustering keywords with a high similarity may be greatly increased.

1) Filtered may be a first text element that includes a phrase related to market conditions among at least one text element included in a text set according to an example embodiment. For example, the electronic device 100 may identify a text element listing a set number of or more target keywords as a first text element including a phrase related to the market conditions. Generally, the news related to market conditions may list multiple stocks with low relevance and list the return rate for each of the plurality of stocks. In other words, a text element including a phrase with a set number (for example, 5) of or more target keywords listed sequentially may be determined to contain phrases related to the market situation. Alternatively, it may be determined that a text element in which large stocks with large market capitalization are listed sequentially as many as a set number (for example, 4) or more among stocks listed on a specific exchange includes phrases related to market conditions. Further, if the text element directly includes phrases related to market conditions, such as “closing market conditions” and “weekly market conditions,” the electronic device 100 may classify the text element as a first text element including phrases related to market conditions.

2) Filtered may be a second text element including advertising text among at least one text element in a text set according to an example embodiment. For example, the advertising text may be one of “This is not a recommendation to buy,” “This is not a recommendation to sell,” and “Please note that you are responsible for your investment.”

In the present disclosure, the set type is not limited to above 1) and 2). The set type may also be added by a user of the electronic device 100.

FIG. 16 relates to an example embodiment of identifying a keyword included in at least one second text element after at least one first text element corresponding to a set type among at least one text element is filtered. In other words, the preprocessing method of FIG. 16 may be a weak preprocessing method that filters only at least one first text element corresponding to a set type.

In operation S1610, the electronic device may identify at least one first text element corresponding to a set type among at least one text element.

In operation S1620, the electronic device may identify a keyword within at least one second text element after at least one first text element among at least one text element is filtered.

FIG. 17 relates to an example embodiment of identifying a keyword based on a second text set in which first text data including at least one first text element corresponding to a set type is filtered from a text set. In other words, the preprocessing method of FIG. 17 may be a strong preprocessing method of filtering first text data itself including at least one first text element corresponding to a set type.

In operation S1710, the electronic device may identify at least one first text element corresponding to a set type among at least one text element.

In operation S1720, the electronic device may identify a second text set in which the first text data including at least one first text element is filtered from the text set. The second text set may include text data in which the first text data including the first text element among the text data included in the text set is filtered.

In operation S1730, the electronic device may identify a keyword within at least one second text element included in the second text set.

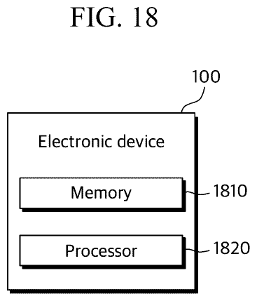

FIG. 18 shows a block diagram of an electronic device according to an example embodiment.

The electronic device 100 of FIG. 18 may correspond to the electronic device of the present disclosure. According to an example embodiment, the electronic device 100 may include a memory 1810 and one or more processors 1820. According to various example embodiments, the electronic device 100 may further include other general-purpose elements in addition to the elements illustrated in FIG. 18. For example, the electronic device 100 may further include a transceiver (not illustrated). In addition, omission or addition regarding elements of the electronic device 100 may be understood by those of ordinary skill in the art to which the example embodiments pertains.

The memory 1810 may store information for performing at least one method described above with reference to FIGS. 1 to 18. The memory 1810 may store one or more instructions to be executed by the one or more processors 1820. The memory 1810 may be referred to as storage and may be volatile memory or non-volatile memory. Further, the memory 1810 may store one or more instructions for performing the operation of the processor 1820 and may temporarily store data stored on the platform or in an external memory. According to an example embodiment, the memory 1810 may store text data included in a text set. Further, the memory 1810 may store a keyword set, a target keyword set, and a vector corresponding to each of at least one target keyword.

One or more processors 1820 may control the overall operation of the electronic device 100 and process data and signals. The one or more processors 1820 may perform one of the methods described above with reference to FIGS. 1 to 18. The one or more processors 1820 may be composed of at least one hardware unit. Further, the one or more processors 1820 may operate by one or more software modules generated by executing one or more instructions stored in the memory 1810.

The one or more processors 1820 may control embodiments performed by the electronic device 100 through interaction with the memory 1810 and further with elements that the electronic device 100 may include.

According to an example embodiment, by executing one or more instructions, the one or more processors 1820 may identify a text set including at least one text element, identify a keyword set including a keyword in the at least one text element, the keyword set including at least one target keyword, identify at least one vector corresponding to each of the at least one target keyword, the at least one vector having elements identified based on a degree of association between the at least one target keyword and each of keywords included in the keyword set, the degree of association being identified based on the text set, based on the identified at least one vector, identify a similarity between the at least one target keyword, by clustering the at least one target keyword based on the similarity, identify at least one set including at least some of the at least one target keyword, and generate information about the at least one set.

The transceiver (not illustrated) is a device for performing wired/wireless communication and may communicate with an external electronic device. The external electronic device may be the terminal 110 or a server. Further, communication technologies used by the transceiver may include global system for mobile communication (GSM), code division multi access (CDMA), long term evolution (LTE), 5G, wireless LAN (WLAN), wireless-fidelity (Wi-Fi), Bluetooth, radio frequency identification (RFID), infrared data association (IrDA), ZigBee, and near field communication (NFC). According to an example embodiment, the transceiver may transmit information about at least one set to the terminal 110 and may receive an output corresponding to a user input from the terminal 110 through an output interface of the terminal 110.

Meanwhile, in the present disclosure and drawings, example embodiments are disclosed, and certain terms are used. However, the terms are only used in general senses to easily describe the technical content of the present disclosure and to help the understanding of the present disclosure, but not to limit the scope of the present disclosure. It is apparent to those of ordinary skill in the art to which the present disclosure pertains that other modifications based on the technical spirit of the present disclosure may be implemented in addition to the example embodiments disclosed herein.

The electronic device or the terminal according to the above-described example embodiments may include a processor, a memory for storing and executing program data, a permanent storage such as a disk drive, and/or a user interface device such as a communication port, a touch panel, a key, and/or an icon that communicates with an external device. Methods implemented as software modules or algorithms may be stored in a computer-readable recording medium as computer-readable codes or program instructions executable on the processor. Here, the computer-readable recording medium includes a magnetic storage medium (for example, ROMs, RAMs, floppy disks, and hard disks) and an optically readable medium (for example, CD-ROMs and DVDs). The computer-readable recording medium may be distributed among network-connected computer systems, so that the computer-readable codes may be stored and executed in a distributed manner. The medium may be readable by a computer, stored in a memory, and executed on a processor.

The example embodiments may be represented by functional block elements and various processing steps. The functional blocks may be implemented in any number of hardware and/or software configurations that perform specific functions. For example, an example embodiment may adopt integrated circuit configurations, such as memory, processing, logic, and/or look-up table, that may execute various functions by the control of one or more microprocessors or other control devices. Similarly to that elements may be implemented as software programming or software elements, the example embodiments may be implemented in a programming or scripting language such as C, C++, Java, assembler, Python, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing. Terms such as “mechanism,” “element,” “means,” and “configuration” may be used broadly and are not limited to mechanical and physical elements. The terms may include the meaning of a series of routines of software in association with a processor or the like.

The above-described example embodiments are merely examples, and other embodiments may be implemented within the scope of the claims to be described later.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of clustering keywords by an electronic device, the method comprising:
identifying a text set including at least one text element;
identifying a keyword set including a keyword in the at least one text element, the keyword set including at least one target keyword;
identifying at least one vector corresponding to each of the at least one target keyword, an element of the at least one vector being identified based on a degree of association between the at least one target keyword and each of keywords included in the keyword set, the degree of association being identified based on the text set;
based on the identified at least one vector, identifying a similarity between the at least one target keyword;
by clustering the at least one target keyword based on the similarity, identifying at least one set including at least some of the at least one target keyword; and
generating information about the at least one set.

2. The method of claim 1, wherein the text set includes unstructured data related to finance, and
wherein the at least one text element includes at least one sentence in the unstructured data related to finance.

3. The method of claim 1, wherein the keyword set includes a keyword included in the at least one text element which is identified through a named entity recognition (NER) model based on deep learning and a keyword of a set word class in the at least one text element which is identified with morpheme analyzing.

4. The method of claim 1, wherein the identifying of the at least one vector comprises identifying a total number of times that keyword pairs each having a combination of any one of the keywords included in the keyword set and any one of the at least one target keyword are included together in each of the at least one text element included in the text set, and
wherein the degree of association is identified based on the identified total number of times.

5. The method of claim 4, further comprising determining a co-occurrence graph based on the keyword set and the total number of times,
wherein the co-occurrence graph includes nodes and an edges connecting the nodes,
wherein each of the nodes corresponds to one of the keywords included in the keyword set, and
wherein a weight of each of the edges is identified based on a total number of times in which two keywords corresponding to each of a first node and a second node that are connected to the each of the edges are included together in each of the at least one text element.

6. The method of claim 1, wherein the information about the at least one set includes information about a representative keyword of each of the at least one set, and
wherein a first representative keyword corresponding to a first set among the at least one set is determined based on at least one first vector corresponding to at least one first target keyword included in the first set.

7. The method of claim 6, wherein, when the first representative keyword is plural, a sort order of the plurality of first representative keywords is determined based on a degree of association between each of the plurality of first representative keywords and each of the at least one first target keyword.

8. The method of claim 1, wherein the generating of the information about the at least one set comprises, based on information about a rate of return of a target keyword included in each of the at least one set, identifying at least one average rate of return corresponding to the at least one set.

9. The method of claim 1, wherein the identifying of the at least one set comprises, based on a vector corresponding to the target keyword included in each of the at least one set, identifying at least one centroid vector corresponding to the at least one set.

10. The method of claim 9, wherein, a first centroid vector corresponding to a first set among the at least one set is identified based on a normalized at least one first vector obtained by normalizing at least one first vector corresponding to at least one first target keyword included in the first set according to a set rule.

11. The method of claim 9, wherein the identifying of the at least one set comprises:
identifying a first vector corresponding to a first target keyword included in a first set among the at least one set;
identifying at least one second centroid vector corresponding to at least one second set other than the first set among the at least one set;
among the at least one second set, identifying a third set in which a similarity between the first vector and the at least one second centroid vector is greater than or equal to a set value; and
re-identifying the third set in order that the first target keyword is further included in the third set.

12. The method of claim 1, wherein the identifying of the similarity comprises:
based on a cosine similarity between the at least one vector, identifying the similarity between the at least one target keyword.

13. The method of claim 1, wherein the identifying of the keyword set comprises:
identifying at least one first text element corresponding to a set type among the at least one text element; and
identifying a keyword in at least one second text element after the at least one first text element among the at least one text element is filtered.

14. The method of claim 1, wherein the identifying of the keyword set comprises:
identifying at least one first text element corresponding to a set type among the at least one text element;
identifying a second text set in which first text data including the at least one first text element is filtered from the text set; and
identifying a keyword in at least one second text element included in the second text set.

15. The method of claim 1, wherein the text set includes text data generated within a selected period of time.

16. The method of claim 4, wherein the identifying of the total number of times comprises:
based on information about a generation time of each of text data included in the text set, determining a first weight of each of the text data; and
based on the total number of times and the first weight, identifying a modified total number of times for each of the keyword pairs.

17. The method of claim 1, wherein the identifying of the at least one set comprises, based on hierarchical clustering using the similarity, identifying the at least one set including the at least some of the at least one target keyword.

18. The method of claim 1, wherein a target keyword set includes a keyword corresponding to a stock listed on a selected exchange,
wherein the at least one target keyword is a keyword that is included in both the keyword set and the target keyword set, and
wherein, as the target keyword set is updated, the at least one target keyword is updated to include a target keyword included in the updated target keyword set among the keywords included in the keyword set.

19. An electronic device, comprising:
one or more processors; and
a memory storing one or more instructions that are executed by the one or more processors, wherein, by executing the one or more instructions, the one or more processors are configured to:
identify a text set including at least one text element;
identify a keyword set including a keyword in the at least one text element, the keyword set including at least one target keyword;
identify at least one vector corresponding to each of the at least one target keyword, an element of the at least one vector being identified based on a degree of association between the at least one target keyword and each of keywords included in the keyword set, the degree of association being identified based on the text set;
based on the identified at least one vector, identify a similarity between the at least one target keyword;
by clustering the at least one target keyword based on the similarity, identify at least one set including at least some of the at least one target keyword; and
generate information about the at least one set.

20. A non-transitory computer-readable recording medium having contents which cause one or more processors to perform a method, the method comprising:
identifying a text set including at least one text element;
identifying a keyword set including a keyword in the at least one text element, the keyword set including at least one target keyword;
identifying at least one vector corresponding to each of the at least one target keyword, an element of the at least one vector being identified based on a degree of association between the at least one target keyword and each of keywords included in the keyword set, the degree of association being identified based on the text set;
based on the identified at least one vector, identifying a similarity between the at least one target keyword;
by clustering the at least one target keyword based on the similarity, identifying at least one set including at least some of the at least one target keyword; and
generating information about the at least one set.
